(19) United States
(12) Patent Application Publication
(10) Pub. No.: US 2010/0096603 A1
(43) Pub. Date: Apr. 22, 2010

(54) OPTICAL DEVICES RESPONSIVE TO NEAR INFRARED LASER AND METHODS OF MODULATING LIGHT

(75) Inventors: Peng Wang, San Diego, CA (US); Tao Gu, San Diego, CA (US); Donald Flores, San Diego, CA (US); Weiping Lin, Carlsbad, CA (US); Michiharu Yamamoto, Carlsbad, CA (US)

Correspondence Address: KNOBBE MARTENS OLSON & BEAR LLP, 2040 MAIN STREET, FOURTEENTH FLOOR, IRVINE, CA, 92614, US

(73) Assignee: Nitto Denko Corporation, Osaka (JP)

(21) Appl. No.: 12/562,868

(22) Filed: Sep. 18, 2009

Related U.S. Application Data
(60) Provisional application No. 61/106,848, filed on Oct. 20, 2008.

(51) Int. Cl. G02F 1/00; C09K 3/00; B29D 11/00

(52) U.S. Cl. 252/587; 264/1.37; 359/321

(57) ABSTRACT

A photorefractive composition that is photorefractive upon irradiation by a near infrared (NIR) laser. The photorefractive composition comprises a sensitizer and a polymer comprising a repeating unit including at least a moiety selected from the group consisting of the formulae (Ia), (Ib) and (Ic), as defined herein. The photorefractive composition can be used in optical devices.

### CROSS-REFERENCE TO RELATED APPLICATIONS

This application claims priority to U.S. Provisional Application Ser. No. 61/106,848 filed on Oct. 20, 2008, entitled “OPTICAL DEVICES RESPONSIVE TO NEAR INFRARED LASER AND METHODS OF MODULATING LIGHT,” the contents of which are hereby incorporated by reference in their entirety.

### BACKGROUND OF THE INVENTION

1. Field of the Invention

The invention relates to a photorefractive composition comprising a sensitizer and a polymer that is configured to be photorefractive upon irradiation by a near infrared (NIR) laser. More particularly, the polymer comprises a first repeating unit that includes a moiety selected from the group consisting of a carbazole moiety, a tetraphenyl diaminobiphenyl moiety, and a triphenylamine moiety. Additionally, the composition can be configured to be photorefractive upon irradiation with a NIR laser by incorporating a sensitizer that provides necessary absorption coefficiency at the working wavelength. Furthermore, the invention relates to a method for modulating light using the photorefractive composition that is irradiated by a NIR laser. Embodiments of the composition can be used for high-density optical data storage, dynamic holography, optical image processing, phase conjugated mirrors, optical computing, parallel optical logic, pattern recognition, optical communication, and novelty filtering.

2. Description of the Related Art

Photorefractivity is a phenomenon in which the refractive index of a material can be altered by changing the electric field within the material, such as by laser beam irradiation. The change of the refractive index typically involves: (1) charge generation by laser irradiation, (2) charge transport, resulting in the separation of positive and negative charges, (3) trapping of one type of charge (charge delocalization), (4) formation of a non-uniform internal electric field (space-charge field) as a result of charge delocalization, and (5) a refractive index change induced by the non-uniform electric field. Good photorefractive properties are typically observed in materials that combine good charge generation, charge transport or photoconductivity and electro-optical activity. Photorefractive materials have many promising applications, such as high-density optical data storage, dynamic holography, optical image processing, phase conjugated mirrors, optical computing, parallel optical logic, and pattern recognition. Particularly, long lasting grating behavior can contribute significantly for high-density optical data storage or holographic display applications.

Originally, the photorefractive effect was found in a variety of inorganic electro-optical (EO) crystals, such as LiNbO₃. In these materials, the mechanism of a refractive index modulation by the internal space-charge field is based on a linear electro-optical effect.

In 1990 and 1991, the first organic photorefractive crystal and polymeric photorefractive materials were discovered and reported. Such materials are disclosed, for example, in U.S. Pat. No. 5,064,264, the contents of which are hereby incorporated by reference in their entirety. Organic photorefractive materials offer many advantages over the original inorganic photorefractive crystals, such as large optical nonlinearities, low dielectric constants, low cost, lightweight, structural flexibility, and ease of device fabrication. Other important characteristics that may be desirable depending on the application include sufficiently long shelf life, optical quality, and thermal stability. These kinds of active organic polymers are emerging as key materials for advanced information and telecommunication technology.

In recent years, efforts have been made to improve the properties of organic, and particularly polymeric, photorefractive materials. Various studies have been done to examine the selection and combination of the components that give rise to each of these features. Photoconductive capability can be provided by incorporating materials containing carbazole groups. Phenyl amine groups can also be used for the charge transport part of the material.

The photorefractive composition may be made by mixing molecular components that provide desirable individual properties into a host polymer matrix. However, many of the previously prepared compositions failed to show good photorefractivity performances, (e.g., high diffraction efficiency, fast response time and long-term stability). Efforts have been made, therefore, to provide compositions which show high diffraction efficiency, fast response time and long stability.

U.S. Patent App. Pub. No. 2008/0039603 and U.S. Pat. No. 6,653,421, the contents of which are both hereby incorporated by reference in their entirety, disclose (meth)acrylate-based polymers and copolymer based materials which showed high diffraction efficiency, fast response time, and long-term phase stability. The materials show fast response times of less than 30 msec and diffraction efficiency of higher than 50%, along with no phase separation for at least six months.

Efforts have been made to provide compositions which are sensitive to IR or NIR region. IR (800 to 1550 nm) sensitization of several photorefractive polymers has been previously demonstrated in Mecher et al., Nature London 418, 959 (2002); Eralp et al., Appl. Phys. Lett. 85, 1095 (2004); Tay et al., Appl. Phys. Lett., 85, 4561 (2004); Tay et al., Appl. Phys. Lett., 87, 171105 (2005); and Choudhury et al., 17, 2877 (2005). However, none of these materials have achieved the desired combination of high photorefractivity (high diffraction efficiency and large two beam coupling gain) and fast response time with long device lifetime. In Mecher's work, the composition needs a complicated pre-illumination to achieve fast writing. In Eralp's work, the high performance device (C2, gain over 110 cm⁻¹) is only phase stable for a few weeks, whereas the phase stable C1 compositions are not high performance and only provide a gain of around 60 cm⁻¹. In Choudhury's work, introduction of a quantum-dot reduces the lifetime of the photorefractive device. Thus, there remains a need for optical devices comprising materials that combine good photorefractivity performances, fast response times, good device lifetime and that are configured to be photorefractive upon irradiation with a NIR laser.

### SUMMARY OF THE INVENTION

Described herein are photorefractive compositions and methods of using thereof. Grating signals can be written into embodiments of the photorefractive compositions and held after several minutes, or longer, for data or image storage purpose. Preferred photorefractive compositions show fast response times and good diffraction efficiencies and large two-beam coupling gain to NIR lasers. Furthermore, grating signals can also be rewritten into preferred compositions after initial exposure. The availability of such materials that are sensitive to a NIR continuous wave (CW) laser system can be greatly advantageous and useful for industrial application purposes.

The photorefractive compositions can comprise a hole-transfer type polymer in combination with a sensitizer, and may be formulated to exhibit fast response times, high diffraction efficiency, large two-beam coupling gain, and/or good phase stability. More specifically, the polymer may comprise at least a first repeating unit that includes a moiety selected from the group consisting of a carbazole moiety, a tetraphenyl diaminobiphenyl moiety, and a triphenylamine moiety. In some embodiments, the composition can be used for holographic data storage, as image recording materials, and in optical devices.

In an embodiment, a composition configured or formulated to be photorefractive upon irradiation by a near infrared laser (NIR) is provided. In an embodiment, the composition comprises a sensitizer and a polymer, wherein the polymer comprises a first repeating unit which includes at least one moiety selected from the group consisting of the following formulae (Ia), (Ib), and (Ic):

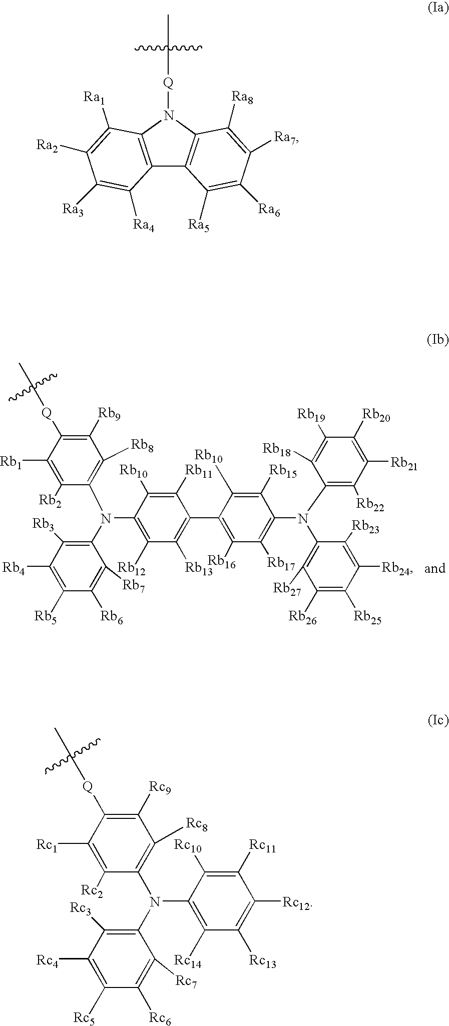

In an embodiment, each Q in formulae (Ia), (Ib) and (Ic) independently represents an alkylene group or a heteroalkylene group, Ra₁-Ra₈, Rb₁-Rb₂₇ and Rc₁-Rc₁₄ in (Ia), (Ib), and (Ic) are each independently selected from the group consisting of hydrogen, linear or branched optionally substituted C₁-C₁₀ alkyl or heteroalkyl, and optionally substituted C₆-C₁₀ aryl.

Various sensitizers that are sensitive to a NIR laser in the composition can be used. For example, the sensitizer can absorb light emitted at a NIR laser wavelength. Preferably, the sensitizer provides non-linear optical functionality in the NIR range. In an embodiment, the sensitizer is selected from the group consisting of a fullerene, a nitro-substituted fluorenone, and a second order nonlinear sensitizer with the following structure (II):

W—Y—Z (II)

such that the structure (II) provides photosensitivity at the NIR laser wavelength in the composition. W in formula (II) is an electron donor group, Y in formula (II) is a π-conjugated group, and Z in formula (II) is an electron acceptor group. In an embodiment, the composition comprises sensitizer in an amount in the range of about 0.01% to about 5% by weight of the composition

Another embodiment provides an optical device which comprises any of the photorefractive compositions described herein. Another embodiment provides a method for modulating light, comprising the steps of providing a photorefractive composition described herein, and irradiating the photorefractive composition with a NIR laser to form a grating, thereby modulating light.

Embodiments of compositions described herein can be utilized in a variety of optical applications, including high-density optical data storage, dynamic holography, optical image processing, phase conjugated, optical computing, parallel optical logic, and pattern recognition, optical correlation, medical imaging, and novelty filtering.

### BRIEF DESCRIPTION OF THE DRAWINGS

FIG. 1 is a schematic depiction illustrating a hologram recording system with a photorefractive composition.

### DETAILED DESCRIPTION OF THE INVENTION

While some photorefractive compositions respond favorably to visible laser at red (about 633 nm), green (about 532 nm), or blue (488 nm) wavelength, their chemical and optical properties are generally incompatible with the absorbance and transmittance of NIR light. Preferred compositions described herein exhibit photorefractive behavior to NIR laser.

In some embodiments, the composition can be made photorefractive upon irradiation by a NIR continuous wave (CW) laser. The photorefractive composition comprises a sensitizer and a polymer, formulated such that the composition exhibits photorefractive behavior upon irradiation by a NIR laser. The polymer comprises a repeating unit that include at least one moiety selected from the group consisting of the carbazole moiety (represented by formula (Ia)), tetraphenyl diaminobiphenyl moiety (represented by the formula (Ib)), and triphenylamine moiety (represented by the formula (Ic)).

Each of the alkyl, heteroalkyl, or aryl groups in formulae (Ia), (Ib), and (Ic) can be “optionally substituted” with one or more substituent group(s). When substituted, the substituent group(s) is(are) one or more group(s) individually and independently selected from alkyl, alkenyl, alkynyl, cycloalkyl, cycloalkenyl, cycloalkynyl, aryl, heteroaryl, heteroalicyclyl, aralkyl, heteroaralkyl, (heteroalicyclyl)alkyl, hydroxy, protected hydroxyl, alkoxy, aryloxy, acyl, ester, mercapto, alkylthio, arylthio, cyano, halogen, carbonyl, thiocarbonyl, O-carbamyl, N-carbamyl, O-thiocarbamyl, N-thiocarbamyl, C-amido, N-amido, S-sulfonamido, N-sulfonamido, C-carboxy, protected C-carboxy, O-carboxy, isocyanato, thiocyanato, isothiocyanato, nitro, silyl, silyl ether, sulfenyl, sulfinyl, sulfonyl, haloalkyl, haloalkoxy, trihalomethanesulfonyl, trihalomethanesulfonamido, and amino, including mono- and di-substituted amino groups, and the protected derivatives thereof. Such a definition for “optionally substituted” applies throughout the specification. Some non-limiting examples of the substituent group(s) include, for example, methyl, ethyl, propyl, butyl, pentyl, isopropyl, methoxide, ethoxide, propoxide, isopropoxide, butoxide, pentoxide and phenyl.

The alkylene or heteroalkylene groups represented by Q in the various formulae described herein, including formulae (Ia), (Ib) and (Ic), can comprise from 1 to about 20 carbon atoms. In an embodiment, Q in formulae (Ia), (Ib) and (Ic) is selected from the group consisting of ethylene, propylene, butylene, pentylene, hexylene, and heptylene, each of which may optionally contain a heteroatom, such as O, N, or S. The heteroalkylene group can comprise one or more heteroatoms. Any heteroatom or combination of heteroatoms can be used, including O, N, S, and any combination thereof.

In some embodiments, the polymer comprising a first repeating unit that includes at least one of formulae (Ia), (Ib), and (Ic) may be polymerized or copolymerized to form a charge transport component of a photorefractive composition. For example, a polymer comprising a first repeating unit that includes only one of the moieties alone may be polymerized to form a photorefractive polymer. In some embodiments, two or more of the (Ia), (Ib), and (Ic) moieties may also be present in a copolymer to form a photorefractive polymer. The polymer or copolymer that includes one, two, or even three of these moieties possesses the charge transport ability.

Each of the moieties of formulae (Ia), (Ib), and (Ic) can be attached to a polymer backbone. Many polymer backbone, including but not limited to, polyurethane, epoxy polymers, polystyrene, polyether, polyester, polyamide, polyimide, polysiloxane, and polyacrylate, with the appropriate side chains attached, can be used to make the polymers of the photorefractive composition. Some embodiments contain backbone units based on acrylates or styrene, and some of preferred backbone units are formed from acrylate-based monomers, and some are formed from methacrylate monomers. It is believed that the first polymeric materials to include photoconductive functionality in the polymer itself were the polyvinyl carbazole materials developed at the University of Arizona. However, these polyvinyl carbazole polymers tend to become viscous when subjected to some of the heat-processing methods used to form the polymer into films or other shapes for use in photorefractive devices.

The (meth)acrylate-based and acrylate-based polymers used in embodiments described herein exhibit good thermal and mechanical properties. Such polymers provide improved durability and workability during processing by injection-molding or extrusion, especially when the polymers are prepared by radical polymerization. Some embodiments provide a composition comprising a sensitizer and a photorefractive polymer that is activated upon irradiation by a NIR laser, wherein the photorefractive polymer comprises a repeating unit selected from the group consisting of the following formulae:

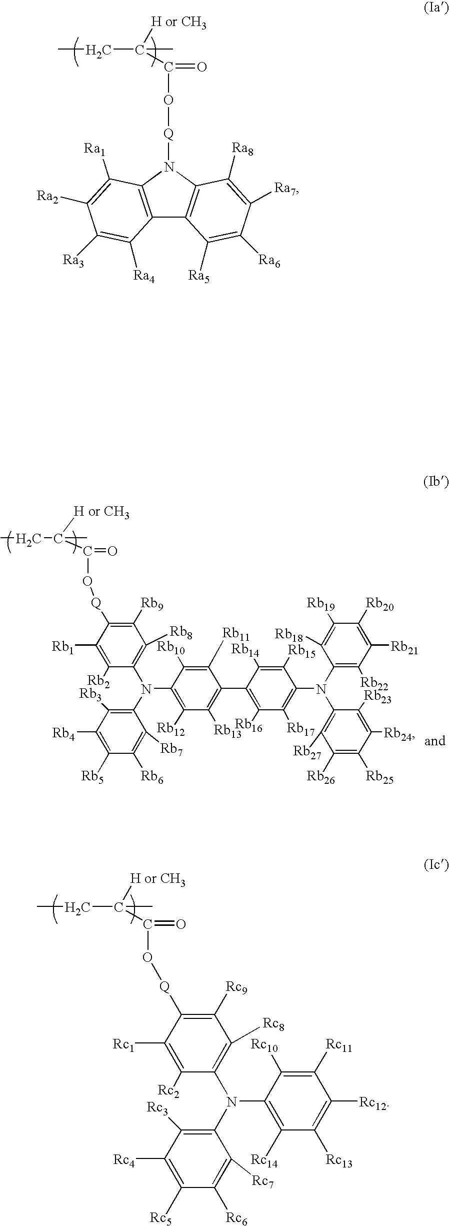

In an embodiment, each Q in formulae (Ia′), (Ib′) and (Ic′) independently represents an alkylene group or a heteroalkylene group. In an embodiment, Ra₁-Ra₈, Rb₁-Rb₂₇ and Rc₁-Rc₁₄ in formulae (Ia′), (Ib′) and (Ic′) are each independently selected from the group consisting of hydrogen, linear or branched optionally substituted C₁-C₁₀ alkyl or heteroalkyl, and optionally substituted C₆-C₁₀ aryl. The heteroalkylene group and the heteroalkyl group can have one or more heteroatoms selected from S, N, or O.

In some embodiments, a polymer comprising at least one repeating unit of formulae (Ia′), (Ib′) and (Ic′) can also be polymerized or copolymerized to form a photorefractive polymer that provides charge transport ability. In some embodiments, monomers comprising a phenyl amine derivative can be copolymerized to form the charge transport component as well. Non-limiting examples of such monomers are carbazolylpropyl (meth)acrylate monomer; 4-(N,N-diphenylamino)-phenylpropyl(meth)acrylate; N-[(meth)acroyloxypropylphenyl]-N,N′,N′-triphenyl-(1,1′-biphenyl)-4,4′-diamine; N-[(meth)acroyloxypropylphenyl]-N′-phenyl-N, N′-di(4-methylphenyl)-(1,1′-biphenyl)-4,4′-diamine; and N-[(meth)acroyloxypropylphenyl]-N′-phenyl-N, N′-di(4-buthoxyphenyl)-(1,1′-biphenyl)-4,4′-diamine. These monomers can be used to form polymer by themselves or to form copolymers, e.g., by polymerization of a mixture of two or more monomers.

The photorefractive composition comprises a sensitizer, such that the photorefractive composition is responsive upon irradiation with a NIR laser. In an embodiment, the sensitizer absorbs light at the NIR laser wavelength. As used herein, a sensitizer that “absorbs light at the NIR laser wavelength” is a sensitizer that can absorb at least about 10% of incident NIR wavelength light. The sensitizer can absorb more than 10% of incident NIR wavelength light. In an embodiment, the sensitizer absorbs at least about 20% of incident NIR wavelength light. In an embodiment, the sensitizer absorbs at least about 30% of incident NIR wavelength light. In an embodiment, the sensitizer absorbs at least about 40% of incident NIR wavelength light. In an embodiment, the sensitizer absorbs at least about 50% of incident NIR wavelength light. In an embodiment, the sensitizer absorbs at least about 60% of incident NIR wavelength light. Preferably, the sensitizer forms a charge-transfer complex with the above mentioned polymers, and the charge-transfer complex will then provide the necessary sensitivity of the composition for desired NIR wavelength.

One suitable sensitizer includes a fullerene. “Fullerenes” are carbon molecules in the form of a hollow sphere, ellipsoid, tube, or plane, and derivatives thereof. One example of a spherical fullerene is C₆₀. While fullerenes are typically comprised entirely of carbon molecules, fullerenes may also be fullerene derivatives that contain other atoms, e.g., one or more substituents attached to the fullerene. In an embodiment, the sensitizer is a fullerene selected from C₆₀, C₇₀, C₈₄, each of which may optionally be substituted. In an embodiment, the fullerene is selected from soluble C₆₀ derivative [6,6]-phenyl-C61-butyricacid-methylester, soluble C₇₀ derivative [6,6]-phenyl-C₇₁-butyricacid-methylester, or soluble C₈₄ derivative [6,6]-phenyl-C₈₅-butyricacid-methylester. Fullerenes can also be in the form of carbon nanotubes, either single-wall or multi-wall. The single-wall or multi-wall carbon nanotubes can be optionally substituted with one or more substituents.

Another suitable sensitizer includes a nitro-substituted fluorenone. Non-limiting examples of nitro-substituted fluorenones include nitrofluorenone, 2,4-dinitrofluorenone, 2,4,7-trinitrofluorenone, and (2,4,7-trinitro-9-fluorenylidene)malonitrile.

The sensitizer can also comprise certain second order nonlinear chromophores represented by the formula (II): W—Y—Z, as described above. In an embodiment, the charge redistribution by the strong donor and acceptor pair and the π-conjugated bridge in the sensitizer represented by formula (II) generates sufficient absorption at the desired working NIR wavelength, such as between about 700 nm and about 1320 nm, for example between about 800 nm and 1100 nm or more typically about 980 nm, when present in the photorefractive composition. The photorefractive composition can absorb the NIR wavelength light when a relatively high electron affinity acceptor is used with a long π-conjugated group.

The electron donor W has low electron affinity when compared to the electron affinity of the electron acceptor Z. Non-limiting examples of an electron donor W include amino (e.g., NRz₁Rz₂), alkyl (e.g., Rz₁), oxy (e.g., ORz₁), phosphino (e.g., PRz₁Rz₂), silicate (e.g., SiRz₁Rz₁ₐRz₂), and thio (e.g., SRz₁), wherein Rz₁, Rz₁ₐ, and Rz₂ are C₁-C₂₀ moieties that can each be independently selected from the group consisting of alkenyl, alkyl, alkynyl, aryl, cycloalkenyl, cycloalkyl, heteroaryl, and optionally substituted variants thereof. In an embodiment, a heteroaryl has at least one heteroatom selected from O, N, and/or S.

In an embodiment, W in formula (II) is selected from the group consisting NRz₁Rz₂, Rz₁, and ORz₁, wherein Rz₁ and Rz₂ are independently selected from the group consisting of —(CH₂)ₓ—O—C(O)—Rz₃, —(CH₂)ₓNH—C(O)Rz₃, alkenyl, alkyl, alkynyl, aryl, cycloalkenyl, cycloalkyl, heteroaryl, and optionally substituted variants thereof, wherein x in W of formula (II) is between 1 and about 6 and Rz₃ is an optionally substituted aryl, heteroaryl, heterocycle, cycloalkyl, alkenyl, or alkynyl.

Some non-limiting examples of useful electron donor W moieties include:

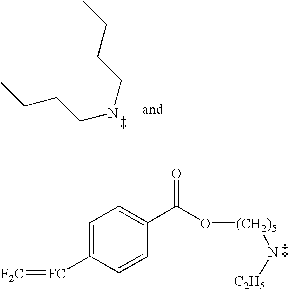

The symbol “‡” in a chemical structure specifies an atom of attachment to another chemical group and indicates that the structure is missing a hydrogen that would normally be implied by the structure in the absence of the “‡”.

The π-conjugated group Y in formula (II) refers to a molecular fragment that contains π-conjugated bonds, thus forming a π-conjugated system. π-conjugated bonds refer to covalent bonds between atoms that have σ bonds and π bonds formed between two atoms by overlapping of atomic orbits (s+p hybrid atomic orbits for σ bonds and p atomic orbits for π bonds). In some embodiments, suitable π-conjugated groups include at least one of the following groups: aromatics and condensed aromatics, polyenes, polyynes, quinomethides, and corresponding heteroatom substitutions thereof (e.g. furan, pyridine, pyrrole, and thiophene). In some embodiments, suitable π-conjugated groups include at least one heteroatom replacement of a carbon in a C═C or C≡C bond and combinations thereof, with or without substitutions. In some embodiments, the suitable π-conjugated groups include no more than two of the preceding groups described in this paragraph.

Preferably, the π-conjugated group Y contains multiple atoms that are in the π-conjugated system. For example, the following π-conjugated groups, each of which can be used for Y in formula (II) have 8 (formula (XI)) and 11 (formula (XII)) atoms, respectively, in the π-conjugated system:

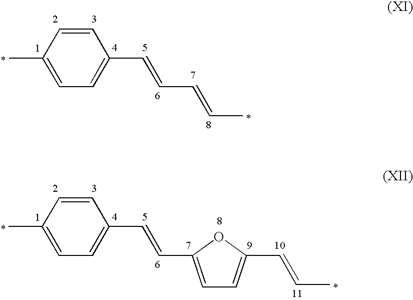

For purposes of determining the number of atoms in the π-conjugated system, the number of atoms in the π-conjugated system refers to non-H atoms. A person of ordinary skill in the art will recognize that the structure of formula (XII) can also be counted as having 12 atoms in the π-conjugated system by counting the 2 carbon atoms in the furan ring instead of the single oxygen atom in the furan ring. In an embodiment, Y comprises a π-conjugated system comprising at least 8 atoms. In an embodiment, Y comprises a π-conjugated system comprising at least 9 atoms. In an embodiment, Y comprises a π-conjugated system comprising at least 10 atoms. In an embodiment, Y comprises a π-conjugated system comprising at least 11 atoms. In an embodiment, Y comprises a π-conjugated system comprising at least 12 atoms. In an embodiment, Y comprises a π-conjugated system comprising at least 13 atoms.

Each of the π-conjugated groups Y can be substituted with a carbocyclic or heterocyclic ring, condensed or appended to the π-conjugated group. Non-limiting examples of π-conjugated groups for Y in formula (II) include:

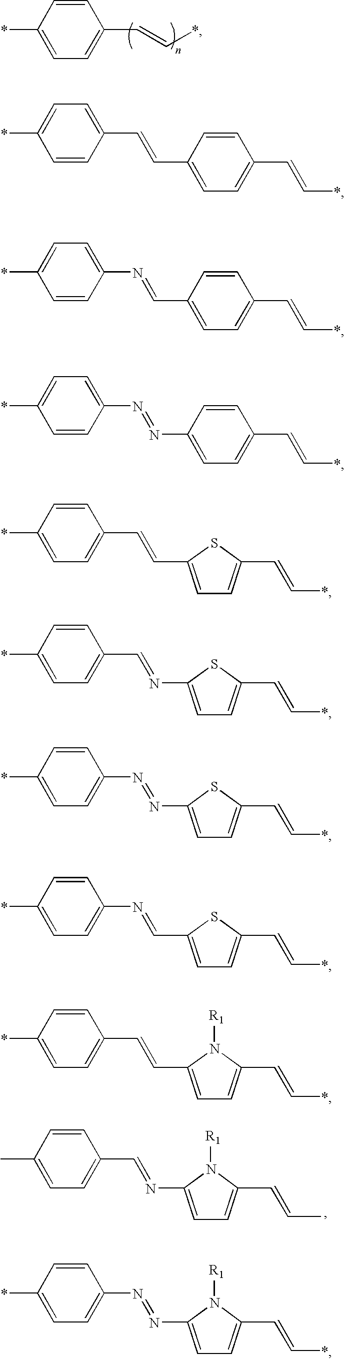

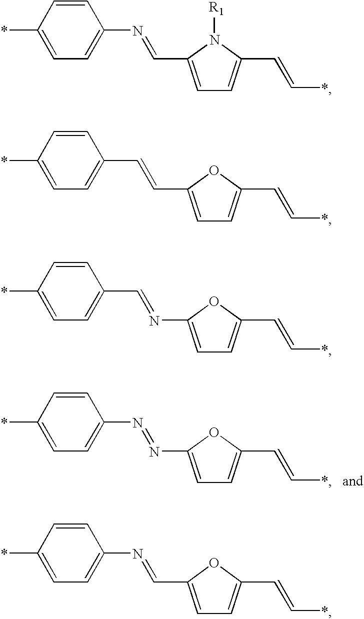

wherein n in Y of formula (II) is 2 or more and R₁ in Y of formula (II) is independently selected from the group consisting of hydrogen, alkenyl, alkyl, alkynyl, aryl, cycloalkenyl, cycloalkyl, heteroaryl, and optionally substituted variants thereof. In an embodiment, n in Y of formula (II) is 3.

Z in formula (II) is an electron acceptor group that provides sufficient charge transport so that when the sensitizer is present in the photorefractive composition, the photorefractive composition is reactive to NIR laser. Preferably, Z in formula (II) is chosen such that the charge redistribution by the strong donor and acceptor pair and the π-conjugated bridge in the sensitizer generates sufficient absorption at the desired working NIR wavelength.

Preferably, the electron acceptor group Z in formula (II) comprises a moiety having a relatively high electron affinity. For example the electron acceptor group Z in formula (II) can comprise a moiety having an electron affinity equal to or greater than that of (Z-1):

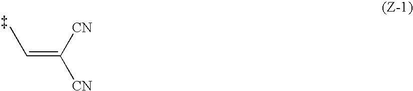

A person having ordinary skill in the art, guided by the disclosure herein, can readily recognize moieties having electron affinity greater than or equal to that of (Z-1) using standard techniques. For example, the electrophilicity index, ω, of a moiety describes its affinity for electrons and may be used to compare the electrophilicity of various moieties. See Parr et al., 1999J. Am. Chem. Soc., 121, 1922. Another useful measurement for electron affinity includes the use of Hammett constants, which is well known in predicting quantitative structural activity and reactivity parlance. See Elango et al, “Relationship between electrophilicity index, Hammett constant and nucleus-independent chemical shift,” J. Chem. Sci., Vol. 117, No. 1, January 1995, pp. 61-65. Providing an electron acceptor group Z in formula (II) having a relatively high electron affinity assists in rendering the sensitizer responsive to light from an NIR wavelength.

In an embodiment, Z in formula (II) comprises a moiety selected from the following structures:

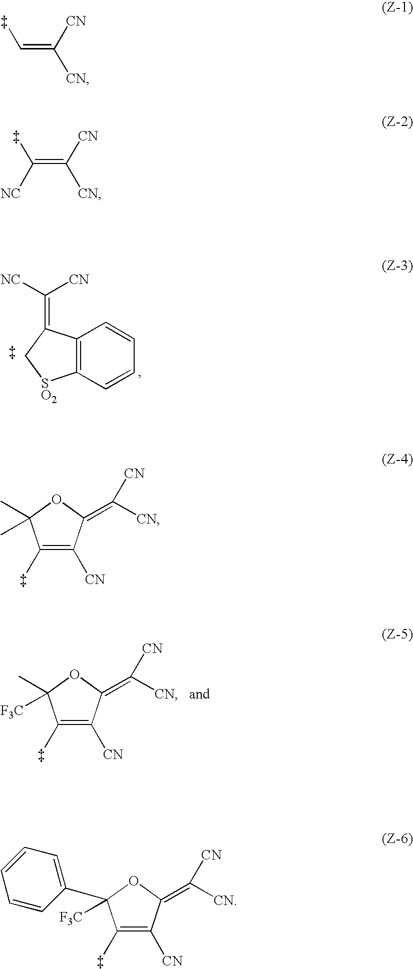

The amount of sensitizer in the composition can vary. In an embodiment, the amount of sensitizer in the composition is from about 0.01% to about 5% based on the weight of the composition. In an embodiment, the amount of sensitizer in the composition is from about 0.05% to about 3% based on the weight of the composition. In an embodiment, the amount of sensitizer in the composition is from about 0.1% to about 2% based on the weight of the composition.

In an embodiment, the sensitizer comprises a molecule according to formula (V):

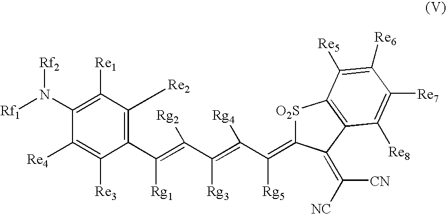

wherein Re₁-Re₈ and Rg₁-Rg₅ in formula (V) are each independently selected from the group consisting of hydrogen, linear or branched C₁-C₁₀ alkyl or heteroalkyl, C₆-C₁₀ aryl, and halogen. In an embodiment, Rf₁ and Rf₂ in formula (V) are each independently selected from the group of hydrogen, linear or branched optionally substituted C₁-C₁₀ alkyl. If the sensitizer according to formula (V) is directly bonded to the polymer, the site of the covalent bond can be at any of the Re₁-Re₈, Rf₁, Rf₂, or Rg₁-R₅ locations.

Preferably, Re₁-Re₈ and Rg₁-Rg₅ are each independently selected from the group consisting of hydrogen and linear or branched C₁-C₄ alkyl or heteroalkyl; and Rf₁ and Rf₂ are each independently selected from the group of linear or branched C₁-C₁₀ alkyl, CH₂CH₂OH, CH₂CH₂OCOCH₃, and CH₂CH₂OSi(CH₃)₂C(CH₃)₃. In an embodiment, the sensitizer comprises 2-[2-{5-[4-(di-n-butylamino)phenyl]-2,4-pentadienylidene-1,1-dioxido-1-benzothien-3(2H)-ylidene]malononitrile (DBM):

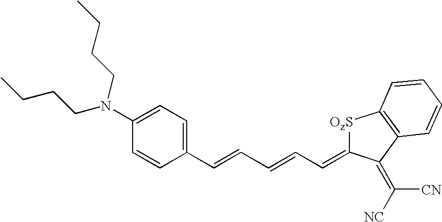

In an embodiment, the sensitizer comprises 2-dicyanomethylene-3-cyano-4-{2-[E-(4,-N,N-ethyl-(4-trifluorovinyl-benzoate-pentyl)amino)-phenylene-thien-5]-E-vinyl]}-5,5-dimethyl-2,5-dihydrofuran (TF-FTC):

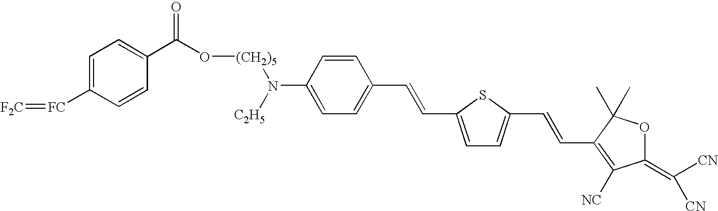

In some embodiments, the photorefractive composition further comprises another component that also has non-linear optical functionality, e.g., chromophores. Moieties or chromophores with non-linear optical functionality may be incorporated into the polymer matrix as an additive to the composition or as functional groups attached to monomers to be copolymerized. Such moieties and chromophores can be sensitive to wavelength light other than NIR. Moieties or chromophores can be any group known in the art to provide non-linear optical capability.

In an embodiment, a monomer comprising a chromorphore can be copolymerized with the first repeating unit described above. Such a monomer comprising a chromophore is used to prepare the non-linear optical component of the polymer. Non-limiting examples of monomers including a chromophore group as the non-linear optical component include N-ethyl, N-4-dicyanomethylidenyl acrylate and N-ethyl, N-4-dicyanomethylidenyl-3,4, 5,6,10-pentahydronaphtylpentyl acrylate.

The amount of chromophore in the photorefractive composition can vary. In an embodiment, chromophore is provided in the composition in an amount in the range of about 0.1% to about 70% based on the weight of the composition. In an embodiment, chromophore is provided in the composition in an amount in the range of about 5% to about 60% based on the weight of the composition. In an embodiment, chromophore is provided in the composition in an amount in the range of about 10% to about 50% based on the weight of the composition. In an embodiment, chromophore is provided in the composition in an amount in the range of about 20% to about 40% based on the weight of the composition.

Other chromophores that possess non-linear optical properties in a polymer matrix are described in U.S. Pat. No. 5,064,264 (incorporated herein by reference) and may also be used in some embodiments. Additional suitable materials known in the art may also be used, and are well described in the literature, such as D. S. Chemla & J. Zyss, “Nonlinear Optical Properties of Organic Molecules and Crystals” (Academic Press, 1987). U.S. Pat. No. 6,090,332 also describes useful fused ring bridge and ring locked chromophores that can form thermally stable photorefractive compositions. Each of the aforementioned documents are incorporated herein by reference in their entirety.

In some embodiments, the ingredient that provides additional non-linear optical properties is represented by formula (III):

D-B-A (III),

wherein D is an electron donor group; B is a π-conjugated group; and A is an electron acceptor group. The ingredient of formula (III) does not absorb light at the NIR laser wavelength, which means that the ingredient of formula (III) absorbs less than about 10% of incident NIR wavelength light. In an embodiment, the ingredient of formula (III) absorbs less than about 5% of incident NIR wavelength light. In an embodiment, the ingredient of formula (III) absorbs less than about 1% of incident NIR wavelength light. In an embodiment, the additional ingredient provides additional non-linear optical functionality under the interaction of optical and electrical field. In an embodiment, the ingredient providing additional non-linear optical functionality comprises a chromophore.

The “electron donor” for group D has low electron affinity when compared to the electron affinity of the electron acceptor A. The electron donor group D can vary. In an embodiment, D in formula (III) is selected from the group consisting of NRz₁Rz₂, Rz₁, ORz₁, PRz₁Rz₂, SiRz₁Rz₁ₐRz₂, and SRz₁; and wherein Rz₁, Rz₁ₐ, and Rz₂ are C₁-C₂₀ moieties that can be independently selected from the group consisting of alkenyls, alkyls, alkynyls, aryls, cycloalkenyls, cycloalkyls, heteroaryls, and optionally substituted variants thereof.

Likewise, the “electron acceptor” for group A is has high electron affinity when compared to the electron affinity of D. However, the electron acceptor group A generally has less electron affinity than the sensitizer electron acceptor group Z described above in formula (II). In an embodiment, A has an electron affinity less than that of (Z-1):

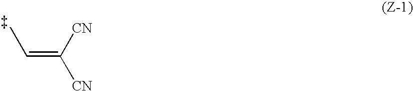

In some embodiments, A is selected from, but not limited to the following: amide; cyano; ester; formyl; ketone; nitro; nitroso; sulphone; sulphoxide; sulphonate ester; sulphonamide; phosphine oxide; phosphonate; N-pyridinium; hetero-substitutions in B; variants thereof; and other positively charged quaternary salts. In some embodiments, A is selected from the group consisting of NO₂, CN, C═C(CN)₂, CF₃, F, Cl, Br, I, S(═O)₂CₙF₂ₙ₊₁, S(CₙF₂ₙ₊₁)═NSO₂CF₃, and S(CₙF₂ₙ₊₁)═NSO₂CₙF₂ₙ₊₁, wherein each n in A of formula (III) is independently an integer from 1 to 10.

The π-conjugated group B in formula (III) preferably has fewer atoms in the π-conjugated system than the π-conjugated group Y in formula (II). However, some larger π-conjugated groups can be used in the ingredient of formula (III) and still not be absorbed by NIR light. This is particularly true when the electron acceptor group A in formula (III) has a relatively lower affinity for electrons. In an embodiment, B in formula (III) comprises a π-conjugated system comprising 12 or less atoms. In an embodiment, B in formula (III) comprises a π-conjugated system comprising 11 or less atoms. In an embodiment, B in formula (III) comprises a π-conjugated system comprising 10 or less atoms. In an embodiment, B in formula (III) comprises a π-conjugated system comprising 9 or less atoms. In an embodiment, B in formula (III) comprises a π-conjugated system comprising 8 or less atoms. In an embodiment, B in formula (III) comprises a π-conjugated system comprising 7 or less atoms. In an embodiment, B in formula (III) comprises π-conjugated system comprising 6 or less atoms.

In an embodiment, B in formula (III) comprises a group selected from an aromatic ring group, a polyene group, a polyyne group, a quinomethide group, and their derivatives containing heteroatoms wherein at least one carbon and/or at least one C═C or C≡C bond is replaced by a heteroatom. In an embodiment, B in formula (III) is selected from the following moieties:

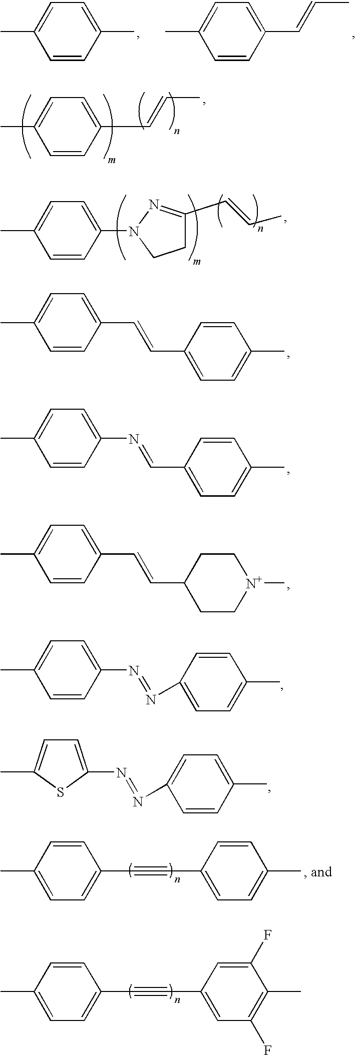

wherein m and n in B of formula (III) are each independently integers of 2 or less, provided that at least one m or n is at least 1.

In an embodiment, the ingredient providing additional non-linear optical functionality comprises a chromophore.

The polymers described herein may be prepared in various ways, e.g., by polymerization of the corresponding monomers or precursors thereof. Polymerization may be carried out by methods known to a skilled artisan, as informed by the guidance provided herein. In some embodiments, radical polymerization using an azo-type initiator, such as AIBN (azoisobutyl nitrile), may be carried out. The radical polymerization technique makes it possible to prepare random or block copolymers comprising both charge transport and non-linear optical groups. Further, by following the techniques described herein, it is possible to prepare such materials with exceptionally good properties, such as photoconductivity and diffraction efficiency. In an embodiment of a radical polymerization method, the polymerization catalyst is generally used in an amount of from 0.01 to 5 mole % or from 0.1 to 1 mole % per mole of the total polymerizable monomers.

In some embodiments, radical polymerization can be carried out under inert gas (e.g., nitrogen, argon, or helium) and/or in the presence of a solvent (e.g., ethyl acetate, tetrahydrofuran, butyl acetate, toluene or xylene). Polymerization may be carried out under a pressure in the range of about 1 Kgf/cm² to about 50 Kgf/cm² or about 1 Kgf/cm² to about 5 Kgf/cm². In some embodiments, the concentration of total polymerizable monomer in a solvent may be about 0.99% to about 50% by weight, preferably about 2% to about 9.1% by weight. The polymerization may be carried out at a temperature of about 50° C. to about 100° C., and may be allowed to continue for about 1 to about 100 hours, depending on the desired final molecular weight, polymerization temperature, and taking into account the polymerization rate.

Some embodiments provide a polymerization method involving the use of a precursor monomer with a functional group for non-linear optical ability for preparing the copolymers. The precursor may be represented by the following formula:

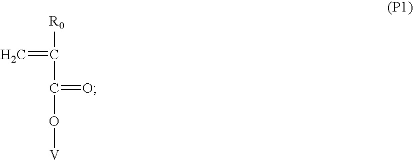

wherein R₀ in (P1) is hydrogen or methyl, and V in (P1) is a group selected from the formulae (V1) and (V2):

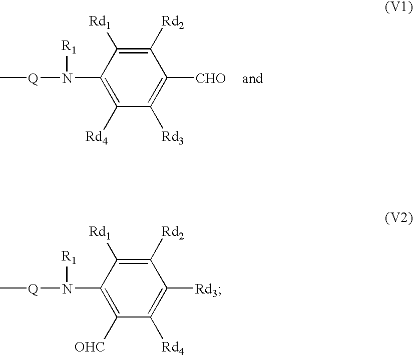

wherein each Q in (V1) and (V2) independently represents an alkylene group or a heteroalkylene group, the heteroalkylene group has one or more heteroatoms such as O, N, and S; Rd₁-Rd₄ in (V1) and (V2) are each independently selected from the group consisting of hydrogen, linear or branched C₁-C₁₀ alkyl, and C₆-C₁₀ aryl, and R₁ in (V1) and (V2) is C₁-C₁₀ alkyl (branched or linear). In some embodiments, Q in (V1) and (V2) may independently be an alkylene group represented by (CH₂)ₚ where p is in the range of about 2 to about 6. In some embodiments, R₁ in (V1) and (V2) is independently selected from the group consisting of methyl, ethyl, propyl, butyl, pentyl and hexyl. In an embodiment, Rd₁-Rd₄ in (V1) and (V2) are hydrogen.

In some embodiments, the polymerization method for the precursor monomer can be carried out under conditions generally similar to those described above. After the precursor copolymer has been formed, it can be converted into the corresponding copolymer having non-linear optical groups and capabilities by a condensation reaction. In some embodiments, the condensation reagent may be selected from the group consisting of:

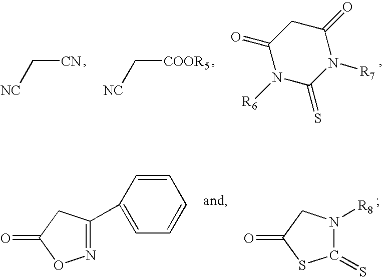

wherein R₅, R₆, R₇ and R₈ of the condensation reagents above are each independently selected from the group consisting of hydrogen, C₁-C₁₀ alkyl and C₆-C₁₀ aryl. The alkyl group may be either branched or linear.

In some embodiments, the condensation reaction between the precursor polymer and the condensation reagent can be carried out in the presence of a pyridine derivative catalyst at room temperature for about 1 to about 100 hrs. In some embodiments, a solvent, such as butyl acetate, chloroform, dichloromethylene, toluene or xylene, can also be used. In some embodiments, the reaction may be carried out without the catalyst at a solvent reflux temperature of 30° C. or above for about 1 to about 100 hours.

In some embodiments, the photorefractive composition further comprises a plasticizer. Any commercial plasticizer such as phthalate derivatives or low molecular weight hole transfer compounds (e.g., N-alkyl carbazole or triphenylamine derivatives or acetyl carbazole or triphenylamine derivatives) may be incorporated into the polymer matrix. A N-alkyl carbazole or triphenylamine derivative containing electron acceptor group is a suitable plasticizer that can help the photorefractive composition be more stable, as the plasticizer contains both N-alkyl carbazole or triphenylamine moiety and non-linear optical moiety in one compound.

Other non-limiting examples of the plasticizer include ethyl carbazole; 4-(N,N-diphenylamino)-phenylpropyl acetate; 4-(N,N-diphenylamino)-phenylmethyloxy acetate; N-(acetoxypropylphenyl)-N,N′,N′-triphenyl-(1,1′-biphenyl)-4,4′-diamine; N-(acetoxypropylphenyl)-N′-phenyl-N,N′-di(4-methylphenyl)-(1,1′-biphenyl)-4,4′-diamine; and N-(acetoxypropylphenyl)-N′-phenyl-N,N′-di(4-buthoxyphenyl)-(1,1′-biphenyl)-4,4′-diamine. Such compounds can be used singly or in mixtures of two or more plasticizers. Also, un-polymerized monomers can be low molecular weight hole transfer compounds, for example 4-(N,N-diphenylamino)-phenylpropyl(meth)acrylate; N-[(meth)acroyloxypropylphenyl]-N,N′, N′-triphenyl-(1,1′-biphenyl)-4,4′-diamine; N-[(meth)acroyloxypropylphenyl]-N′-phenyl-N,N′-di(4-methylphenyl)-(1,1′-biphenyl)-4,4′-diamine; and N-[(meth)acroyloxypropylphenyl]-N′-phenyl-N,N′-di(4-buthoxyphenyl)-(1,1′-biphenyl)-4,4′-diamine. Such monomers can be used singly or in mixtures of two or more monomers.

In some embodiments, a plasticizer may be selected from N-alkyl carbazole or triphenylamine derivatives:

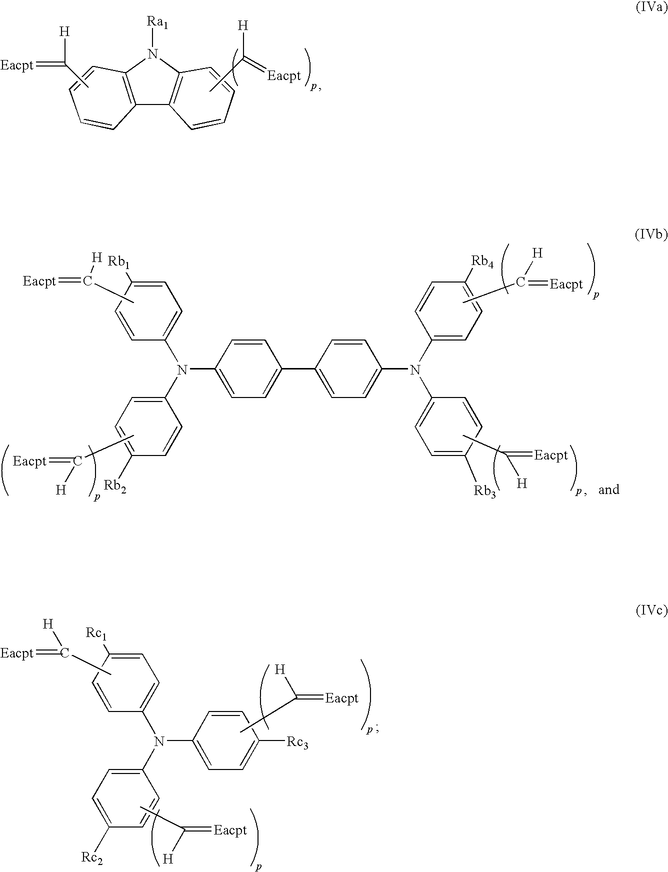

wherein Ra₁, Rb₁-Rb₄ and Rc₁-Rc₃ are each independently selected from the group consisting of hydrogen, branched and linear C₁-C₁₀ alkyl, and C₆-C₁₀ aryl; each p is independently 0 or 1; Eacpt is an electron acceptor group and can be represented by oxygen or a structure selected from the group consisting of the structures;

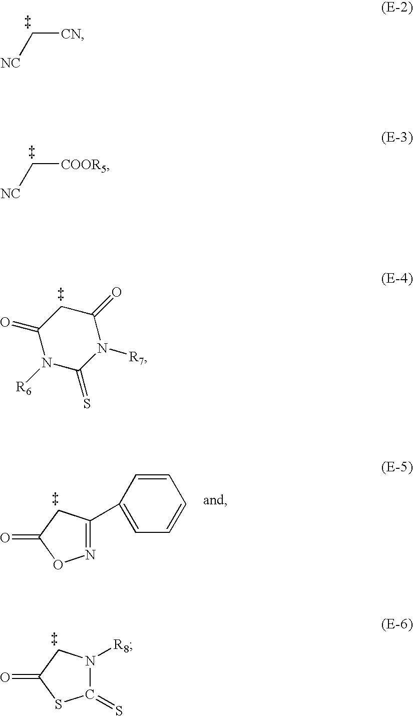

wherein R₅, R₆, R₇ and R₈ in formulae (E-3), (E-4) and (E-6) are each independently selected from the group consisting of hydrogen, linear and branched C₁-C₁₀ alkyl, and C₆-C₁₀ aryl.

In some embodiments, the photorefractive composition comprises a copolymer that provides photoconductive (charge transport) ability and non-linear optical ability. The photorefractive composition may also include other components as desired, such as plasticizer components. Some embodiments provide a photorefractive composition that comprises a copolymer. The copolymer may comprise a first repeating unit that includes a first moiety with charge transport ability, a second repeating unit including a second moiety with non-linear optical ability, and a third repeating unit that include a third moiety with plasticizing ability.

The ratio of different types of monomers used in forming the copolymer may be varied over a broad range. Some embodiments provide a photorefractive composition with a first repeating unit having charge transport ability and a second repeating unit having non-linear optical ability, with a weight ratio of the first repeating unit to the second repeating unit in the range of about 100:1 to about 0.5:1, preferably about 10:1 to about 1:1. When the weight ratio of such a first repeating unit to such a second repeating unit is smaller than about 0.5:1, the charge transport ability of copolymer may be too weak to give sufficient photorefractivity. However, even at such a low ratio, sufficient photorefractivity can still be provided by the addition of low molecular weight components having non-linear-optical ability (e.g., as described elsewhere herein). If the weight ratio for such a first repeating unit to such a second repeating unit is larger than about 100:1, the non-linear optical ability of the copolymer by itself may be too low to provide photorefractivity. However, even at such a high ratio, the addition of low molecular weight components having charge transport ability (e.g., as described elsewhere herein) can enhance photorefractivity.

In some embodiments, the molecular weight and the glass transition temperature, Tg, of the copolymer are selected to provide desirable physical properties. In some embodiments, it is valuable and desirable, although not essential, that the polymer is capable of being formed into films, coatings and shaped bodies of various kinds by standard polymer processing techniques (e.g., solvent coating, injection molding or extrusion).

In some embodiments, the polymer has a weight average molecular weight, Mw, in the range of from about 3,000 to about 500,000, preferably in the range from about 5,000 to about 100,000. The term “weight average molecular weight” as used herein means the value determined by the GPC (gel permeation chromatography) method using polystyrene standards, as is well known in the art. In some embodiments, additional benefits may be provided by lowering the dependence on plasticizers. By selecting copolymers with intrinsically moderate Tg and by using methods that tend to depress the average Tg, it is possible to limit the amount of plasticizer in the composition to no more than about 30% or 25%, and in some embodiments, no more than about 20%. In some embodiments, the photorefractive composition that can be activated by a NIR laser may have a thickness of about 100 μm and a transmittance of higher than about 30%.

An embodiment provides a photorefractive composition that becomes photorefractive upon irradiation by a NIR laser, wherein the photorefractive composition comprises a sensitizer and a polymer comprising a first repeating unit that includes at least one moiety selected from the group consisting of the formulae (Ia), (Ib) and (Ic) as defined above. In some embodiments, the polymer may further comprise a second repeating unit that includes a chromophore moiety. In some embodiments, the polymer may further comprise an ingredient selected from formula (II). In some embodiments, the polymer may further comprise a third repeating unit that includes at least one moiety selected from formulae (IVa), (IVb) and (IVc). In an embodiment, an optical device comprises any one of the photorefractive compositions described herein. Examples of optical devices that comprises the photorefractive composition include high-density optical data storage devices, dynamic holography devices, optical image processing devices, phase conjugated mirrors, optical computing devices, optical switching devices, parallel optical logic devices, pattern recognition devices, and medical imaging devices. The long lasting grating behavior exhibited in the compositions described herein can contribute significantly for high-density optical data storage or holographic display applications.

Another embodiment provides a method of modulating light, comprising irradiating a photorefractive compositions with NIR laser to form a grating, and activating the photorefractive composition, thereby modulating light passing through the photorefractive composition. The photorefractive composition includes all embodiments discussed herein.

Many currently available photorefractive polymers have poor phase stabilities and can become hazy after days. Where the film composition comprising the photorefractive polymer shows significant haziness, poor photorefractive properties are typically exhibited. The haziness of the film composition usually results from incompatibilities between several photorefractive components. For example, photorefractive compositions containing both charge transport ability components and non-linear optical components may exhibit haziness because the components having charge transport ability are usually hydrophobic and non-polar, whereas components having non-linear optical ability are usually hydrophilic and polar. As a result, the natural tendency of the composition is to phase separate, thus causing haziness.

However, preferred embodiments presented herein show very good phase stability and gave no haziness, even after several months. Such compositions retain good photorefractive properties, as the compositions are very stable and exhibit little or no phase separation. Without being bound by theory, the stability is likely attributable to the sensitizer and/or sensitizer provided in a mixture with a chromophore. In addition, the matrix polymer system can be a copolymer of components having charge transport ability and components having non-linear optics ability. That is, the components having charge transport ability and the components having non-linear optical ability can coexist in one polymer chain, therefore rendering significant detrimental phase separation difficult and unlikely.

Furthermore, although heat usually increases the rate of phase separation, preferred compositions described herein exhibit good phase stability, even after being heated. In accelerated heat testing, test samples heated at about 40° C., about 60° C., about 80° C., and about 120° C. are found to be stable after days, weeks, and sometimes even after 6 months. The good phase stability allows the copolymer to be further processed and incorporated into optical device applications for various commercial products.

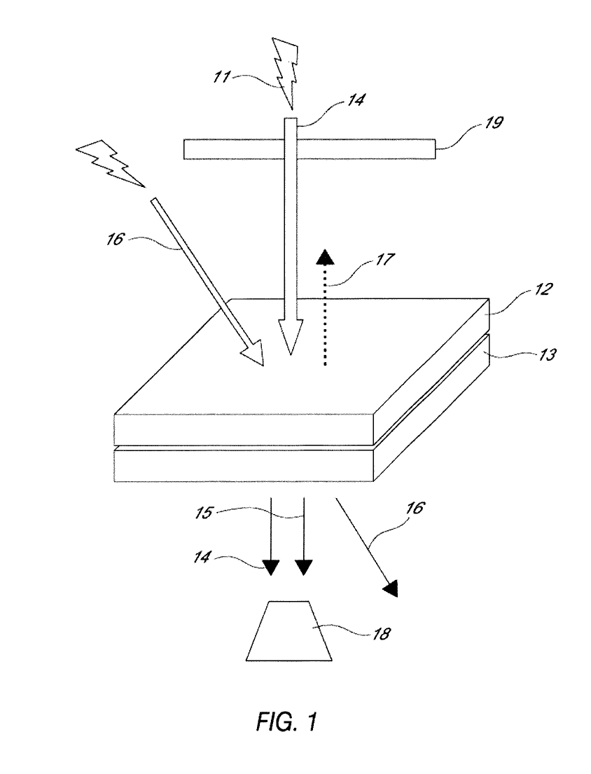

FIG. 1 is a schematic depiction illustrating a non-limiting embodiment of a hologram recording system with a photorefractive composition. Information may be recorded into the hologram medium, and the recorded information may be read out simultaneously. A laser source 11 may be used as to write information onto a recording medium 12. The recording medium 12 comprises the photorefractive polymer described herein and is positioned over a support material 13.

Laser beam irradiation of object beam 14 and reference beam 16 into the recording medium 12 causes interference grating, which generates internal electric fields and a refractive index change. Object beam 14 and reference beam 16 can project from various sides of the device other than those illustrated in FIG. 1. For example, instead of projecting from the same side of the recording medium 12, object beam 14 and reference beam 16 could project from opposite sides of the recording medium 12. Any type of angle between the object beam 14 and reference beam 16 can also be used. Multiple recordings are possible in the photorefractive composition of the recording medium 12 by changing the angle of the incident beam. The object beam 14 has a transmitted portion 15 of the beam and a refracted portion 17 of the beam.

An image display device 19 is set up parallel to the X-Y plane of the recording medium 12. Various types of image display devices may be employed. Some non-limiting examples of image display devices include a liquid crystal device, a Pockels Readout Optical Modulator, a Multichannel Spatial Modulator, a CCD liquid crystal device, an AO or EO modulation device, or an opto-magnetic device. On the other side of the recording medium 12, a read-out device 18 is also set up parallel to the X-Y plane of the recording medium 12. Suitable read-out devices include any kind of opto-electro converting devices, such as CCD, photo diode, photoreceptor, or photo multiplier tube.

In order to read out recorded information, the object beam 14 is shut out and only the reference beam 16, which is used for recording, is irradiated. A reconstructed image may be restored, and the reading device 18 is installed in the same direction as the transmitted portion 15 of the object beam and away from the reference beam 16. However, the position of the reading device 18 is not restricted to the positioning shown in FIG. 1. Recorded information in the photorefractive composition can be erased completely by whole surface light irradiation, or partially erased by laser beam irradiation.

The methods described herein can build the diffraction grating on the recording medium. This hologram device can be used not only for optical memory devices but also in other applications, such as a hologram interferometer, a 3D holographic display, coherent image amplification applications, novelty filtering, self-phase conjugation, beam fanning limiter, signal processing, and image correlation, etc.

In some embodiments for photorefractive devices, the thickness of a photorefractive layer is in the range of from about 10 μm to about 200 μm. Preferably, the thickness range is in the range of about 30 μm to about 150 μm. In many cases, if the sample thickness is less than 10 μm, the diffracted signal is not in the desired Bragg Refraction region, but rather the Raman-Nathan Region, which does not show proper grating behavior. On the other hand, if the sample thickness is greater than 200 μm, composition transmittance for laser beams can often be reduced significantly, resulting in little or no grating signals.

The NIR wavelength that the photorefractive composition can transmit may vary. For example, the composition can transmit NIR laser wavelength between about 700 nm and about 1320 nm. In some embodiments, the composition is configured to transmit NIR laser wavelength between about 800 nm and about 1100 nm. In some embodiments, the composition is configured to transmit 980 nm wave length laser beam. The composition transmittance depends on the photorefractive layer thickness, thus by controlling the thickness of the photorefractive layer comprising a photorefractive composition, the light modulating characteristics can be adjusted as desired. When the transmittance is low, the NIR laser beam may not pass through the layer to form a grating image and signals. On the other hand, if the absorbance is 0%, no laser energy can be absorbed to generate grating signals. In some embodiments, the suitable range of transmittance is about 10% to about 99.99%, about 30% to about 99.9%, and about 40% to about 90%. Linear transmittance was performed to determine the absorption coefficient of the photorefractive device. For measurements, a photorefractive layer was exposed to a 980 nm laser beam with an incident path perpendicular to the layer surface. The beam intensity before and after passing through the photorefractive layer is monitored and the linear transmittance of the sample is given by:

T=^{I}^{_{Transmitted}}/_{I}_{_{incident}}

The wave length of NIR laser is not particularly limited. Typically, a NIR laser is defined as a laser which emits light wave-length of between 700 nm and 1320 nm. For example, a widely available 785 nm, 830 nm, 980 nm, or 1060 nm laser can be used as a NIR light source.

One of the various advantages of preferred photorefractive compositions described herein is a fast response time. Faster response times provide faster grating build-up, which enables the photorefractive composition to be used for wider applications, such as real-time hologram applications. Response time is the time needed to build up the diffraction grating in the photorefractive material when exposed to a laser writing beam. The response time of a sample of material can be measured by transient four-wave mixing (TFWM) experiments, as detailed in the Examples section below. The data may then be fitted with the following bi-exponential function:

η(t)=sin² {η₀(1−a₁e^{-t/J1}−a₂e^{-t/J2})}

with a₁+a₂=1; wherein η(t) is the diffraction efficiency at time t, η₀ is the steady-state diffraction efficiency, and J₁ and J₂ are the grating build-up times. The smaller number of J₁ and J₂ is defined as the response time.

Furthermore, the fast response time can be achieved without using a very high electric field, such as a field in excess of about 100 V/μm (expressed as biased voltage). In an embodiment, a fast response times can generally be achieved at a biased voltage no higher than about 100 V/μm, including about 95 to about 50 V/μm, and about 90 to about 60 V/μm. For example, preferred photorefractive compositions described herein have demonstrated very fast response times of about 15 ms at 980 nm.

An additional advantage of the preferred photorefractive compositions is the high diffraction efficiency, η, that can be achieved. Diffraction efficiency is defined as the ratio of the intensity of a diffracted beam to the intensity of an incident probe beam, and is determined by measuring the intensities of the respective beams. A device is more effective, the closer the ratio is to 100%. In general, for a given photorefractive composition, a higher diffraction efficiency can be achieved by increasing the applied biased voltage. The samples of embodiments described herein could provide at least about 60% and even about 70% of the diffraction efficiency.

Another advantage of preferred embodiments is the large two-beam coupling gain that is attained. During the photorefractive grating formation in the device, an energy transfer occurs between the two writing beams. One beam will gain energy and the other one will loss energy. This phenomenon is very useful for applications like beam steering, signal amplification, etc. Gain (Γ) is defined as below:

$$Γ = \frac{cos φ}{d} ln ( \frac{b γ}{b + 1 - γ} )$$

where d is the thickness of the sample, b=I₂/I₁, γ=I₁₂/I₁, and I₁ and I₁₂ are the transmitted intensity of beam 1 before and after coupling, respectively, and I₂ is the transmitted intensity of beam 2 before coupling. Typical photorefractive devices having photorefractive compositions show absorption coefficiency values (α) of about 30 to about 100 cm⁻¹, and any given sample is only practically useful when gain (Γ) minus the absorption coefficiency value (α) is greater than zero. Generally, for any given photorefractive composition, a larger gain coefficiency can be achieved by increasing the applied biased voltage.

In an embodiment, the photorefractive compositions described herein provide at least about 70 cm⁻¹ gain coefficiency. In an embodiment, the photorefractive compositions described herein provide at least about 100 cm⁻¹ gain coefficiency. In an embodiment, the photorefractive compositions described herein provide at least about 150 cm⁻¹ gain coefficiency. In an embodiment, the photorefractive compositions described herein provide at least about 190 cm⁻¹ gain coefficiency.

The embodiments are now further described by the following examples, which are intended to be illustrative of the invention, but are not intended to limit the scope or underlying principles in any way.

### Example 1

### (a) Monomers Containing Charge Transport Groups

N-[acroyloxypropoxyphenyl]-N,N′,N′-triphenyl-(1,1′-biphenyl)-4,4′-diamine (TPD acrylate) monomer was purchased from Fuji Chemical, Japan, and has the following structure:

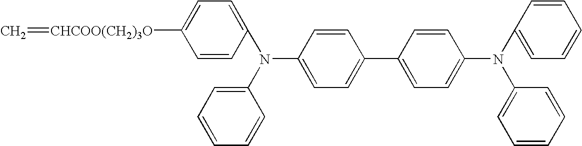

### (b) Monomers Containing Non-Linear Optical Groups

The non-linear optical precursor monomer 5-[N-ethyl-N-4-formylphenyl]amino-pentyl acrylate was synthesized according to the following synthesis scheme:

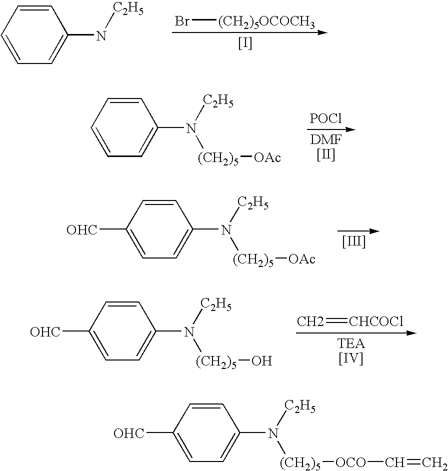

STEP I: Bromopentyl acetate (5 mL, 30 mmol), toluene (25 mL), triethylamine (4.2 mL, 30 mmol), and N-ethylaniline (4 mL, 30 mmol) were added together at room temperature. The mixture was heated at 120° C. overnight. After cooling down, the reaction mixture was rotary-evaporated to form a residue. The residue was purified by silica gel chromatography (developing solvent: hexane/acetone=9/1). An oily amine compound was obtained. (Yield: 6.0 g (80%)).

STEP II: Anhydrous DMF (6 mL, 77.5 mmol) was cooled in an ice-bath. Then, POCl₃ (2.3 mL, 24.5 mmol) was added dropwise into the cooled anhydrous DMF, and the mixture was allowed to come to room temperature. The amine compound (5.8 g, 23.3 mmol) was added through a rubber septum by syringe with dichloroethane. After stirring for 30 min., the reaction mixture was heated to 90° C. and the reaction was allowed to proceed overnight under an argon atmosphere. After the overnight reaction, the reaction mixture was cooled and poured into brine water and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate=3/1). An aldehyde compound was obtained. (Yield: 4.2 g (65%)).

STEP III: The aldehyde compound (3.92 g, 14.1 mmol) was dissolved in methanol (20 mL). Into the solution, potassium carbonate (400 mg) and water (1 mL) were added at room temperature and the solution was stirred overnight. Next, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=1/1). An aldehyde alcohol compound was obtained. (Yield: 3.2 g (96%)).

STEP IV: The aldehyde alcohol (5.8 g, 24.7 mmol) was dissolved in anhydrous THF (60 mL). Into the solution, triethylamine (3.8 mL, 27.1 mmol) was added and the solution was cooled by ice-bath. Acrolyl chloride (2.1 mL, 26.5 mmol) was added and the solution was maintained at 0° C. for 20 minutes. Thereafter, the solution was allowed to warm up to room temperature and stirred at room temperature for 1 hour, at which point TLC indicated that all of the alcohol compound had disappeared. The solution was poured into brine water and extracted by ether. The ether layer was dried over anhydrous magnesium sulfate. After removing the magnesium sulfate, the solvent was removed and the residue acrylate compound was purified by silica gel chromatography (developing solvent: hexane/acetone=1/1). The compound yield was 5.38 g (76%), and the compound purity was 99% (by GC).

### (c) Synthesis of Non-Linear Optical Chromophore 7-FDCST

The non-linear optical precursor 7-FDCST (7 member ring dicyanostyrene, 4-homopiperidino-2-fluorobenzylidene malononitrile) was synthesized according to the following two-step synthesis scheme:

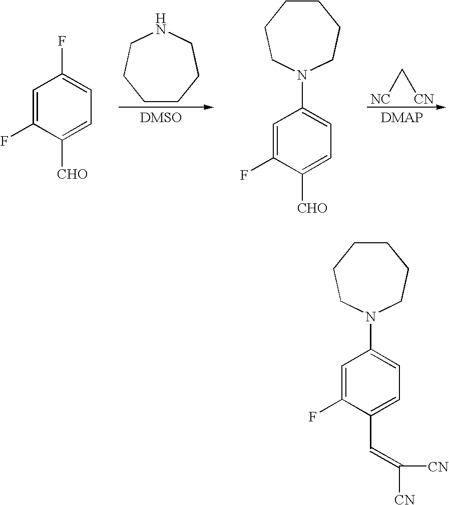

A mixture of 2,4-difluorobenzaldehyde (25 g, 176 mmol), homopiperidine (17.4 g, 176 mmol), lithium carbonate (65 g, 880 mmol), and DMSO (625 mL) was stirred at 50° C. for 16 hours. Water (50 mL) was added to the reaction mixture. The products were extracted with ether (100 mL). After removal of ether, the crude products were purified by silica gel column chromatography using hexanes-ethyl acetate (9:1) as eluent and crude intermediate was obtained (22.6 g). 4-(Dimethylamino)pyridine (230 mg) was added to a solution of the 4-homopiperidino-2-fluorobenzaldehyde (22.6 g, 102 mmol) and malononitrile (10.1 g, 153 mmol) in methanol (323 mL). The reaction mixture was kept at room temperature and the product was collected by filtration and purified by recrystallization from ethanol. The compound yield was 18.1 g (38%).

### (d) Synthesis of Non-Linear-Optical Chromophore 7-DCST

The non-linear-optical precursor 7-DCST (7 member ring dicyanostyrene, 4-homopiperidinobenzylidene malononitrile) was synthesized according to the following two-step synthesis scheme:

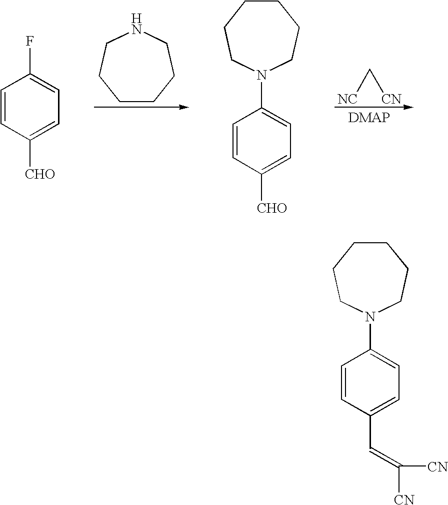

A mixture of 4-fluorobenzaldehyde (17.8 g, 143 mmol), homopiperidine (15.0 g, 151 mmol), lithium carbonate (55 g, 744 mmol), and DMF (100 mL) was stirred at 50° C. for 16 hr. Water (500 mL) was added to the reaction mixture. The products were extracted with ether (1 L). After removal of ether, the crude products were purified by silica gel column chromatography using hexanes-ethyl acetate (9:1) as eluent. 4-(Dimethylamino)pyridine (100 mg, 0.82 mmol) was added to a solution of the 4-homopiperidinobenzaldehyde (18.2 g, 89.5 mmol) and malononitrile (9.1 g, 137.8 mmol) in methanol (60 mL). The reaction mixture was kept at room temperature and the product was collected by filtration and purified by recrystallization from dichloromethane. Yield (17.1 g, 48%)

### (e) Synthesis of Non-Linear Optical Chromophore 2-(3-(4-(azepan-1-yl)phenyl)cyclohex-2-enylidene)malononitrile (ADPC)

1-Phenyl-azepane was synthesized from the reaction of azepane (also known as hexamethyleneimine and hexahydroazepine), sodium amide, and bromobenzene according to a literature procedure (R. E. Walkup and S. Searles, Tetrahedron, 1985, 41, 101-106). Other starting materials were obtained commercially.

A solution of N-bromosuccinimide (1.789 g, 10.1 mmol) in DMF (15 mL) was added dropwise to a solution of 1-phenyl-azepane (1.768 g, 10.1 mmol) in DMF (25 mL) at 0° C. The mixture was allowed to stir and was quenched with 40 mL water after 48 hours. The product was extracted with three 40 mL portions of diethyl ether. The diethyl ether layer was washed with three 40 mL portions of water, then with two 40 mL portions of aqueous 0.01 M sodium thiosulfate, and dried on magnesium sulfate. The diethyl ether was evaporated to afford 1-(4-Bromophenyl)-azepane as a yellowish oil. (1.9721 g, 77.25 mmol, 77% yield).

The 1-(4-Bromophenyl)-azepane (20 g, 78.7 mmol) was dissolved in dry THF (400 mL) under nitrogen gas and cooled to −78° C. tert-Butyl Lithium (92.6 mL of a 1.7 M solution in pentane, 1.45 mol) was added dropwise to the mixture. A solution of 1-ethoxy-2-cyclohexen-3-one (11.45 mL, 78.7 mmol) in dry THF (80 mL) was added dropwise to the mixture. After 36 hours, the reaction was quenched with water (about 250 mL). The reaction was separated with diethyl ether, washed with a saturated sodium chloride solution and dried on magnesium sulfate. The diethyl ether was evaporated and chromatographed on an 8 cm diameter column eluting with 1:1 hexanes/ethyl acetate solution. The resultant product was the ketone 3-(4-(azepan-1-yl)phenyl)cyclohex-2-enone (yellow solid, 16.13 g, 59.8 mmol, 76%).

The 3-(4-(azepan-1-yl)phenyl)cyclohex-2-enone (7.50 g, 27.8 mmol) and malononitrile (9.5 g, 143.8 mmol) were dissolved in ethanol (300 mL). Pipiridine (about 5 mL) was added to the reaction mixture. Type 4A molecular sieves were added. The reaction mixture turned dark red after a couple of minutes and the reaction was stopped after 4.5 hours. The ethanol was evaporated under reduced pressure. The residue was extracted into ethyl acetate, filtered, and ADPC was recrystallized to yield a red solid. (7.11 g, 22.4 mol, 80%).

### (f) Synthesis of DBM Sensitizer

The sensitizer DBM was synthesized according to the literature (Chem. Eur. J. 1997, 3, 1091), the contents of which are hereby incorporated by reference in their entirety. The structure is given below.

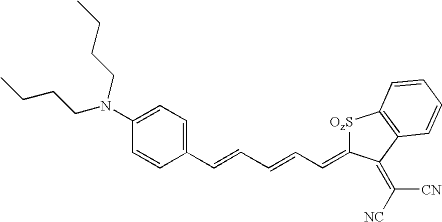

### (g) Synthesis of TF-FTC Sensitizer

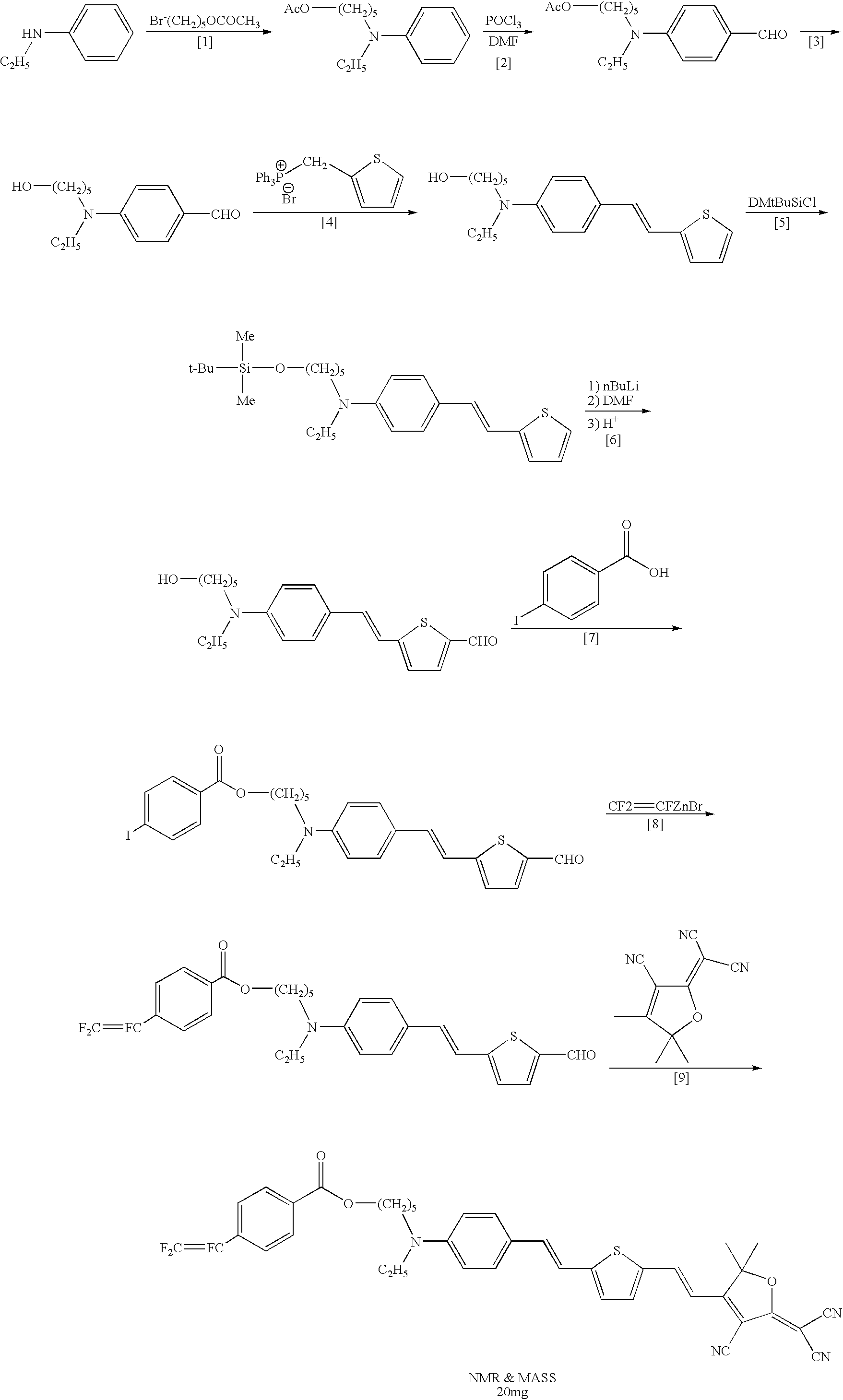

STEP 1: Into a mixture of bromopentyl acetate (5 mL, 30 mmol) and toluene (25 mL), triethylamine (4.2 mL, 30 mmol) and N-ethylaniline (4 mL, 30 mmol) were each added at room temperature. This solution was heated to 120° C. and held overnight. After cooling down, the reaction mixture was rotary-evaporated. The residue was purified by silica gel chromatography (developing solvent: hexane/acetone=9/1). An oily amine compound was obtained. (Yield: 6.0 g (80%))

STEP 2: Anhydrous DMF (6 mL, 77.5 mmol) was cooled in an ice-bath. Then, POCl₃ (2.3 mL, 24.5 mmol) was added dropwise into the 25 mL flask, and the mixture was allowed to come to room temperature. The amine compound (5.8 g, 23.3 mmol) was added through a rubber septum by syringe with dichloroethane. After stirring for 30 min., this reaction mixture was heated to 90° C. and the reaction was allowed to proceed overnight under an argon atmosphere. The next day, the reaction mixture was cooled, and poured into water and extracted by ether. The ether layer was washed with potassium carbonate solution and dried over anhydrous magnesium sulfate. After removing the magnesium sulfate, the solvent was removed and the residue was purified by silica gel chromatography (developing solvent: hexane/ethyl acetate=3/1). An aldehyde compound was obtained. (Yield: 4.2 g (65%))

STEP 3: The aldehyde compound (3.92 g, 14.1 mmol) was dissolved with methanol (20 mL). Into this mixture, potassium carbonate (400 mg) and water (1 mL) were added at room temperature and the solution was stirred overnight. The next day, the solution was poured into brine water and extracted by ether. The ether layer was dried over anhydrous magnesium sulfate. After removing the magnesium sulfate, the solvent was removed and the residue was purified by silica gel chromatography (developing solvent: hexane/acetone=1/1). An aldehyde alcohol compound was obtained. (Yield: 3.2 g (96%))

STEP 4: The starting aldehyde alcohol (5 g, 21.2 mmol) was dissolved in 56 mL of absolute ethanol along with thiophene salt (2.15 g, 21.2 mmol). To this solution was added, dropwise, a 0.85 M solution of sodium ethoxide (2.15 g of NaOEt dissolved in 37 mL ethanol). After addition, the mixture was placed into an 80° C. bath. The clear yellow solution was rotoevaporated after 5 hours. The mix was purified by silica gel chromatography (using 1 Hex: 1 Eth Aoc) as eluent. The product was a yellow oil. The yield was 77%.

STEP 5: The starting alkene (4 g, 12.7 mmol) was dissolved in 50 mL of dry DMF. The reaction mixture was cooled with an ice bath. Added to the mixture was silane reagent (2.3 g, 15.2 mmol) and imidazole (2.1 g, 30.8 mmol), and the mixture was stirred at room temperature for 20 min. The reaction mix was extracted with water and pentane after which the organic layer was rotoevaporated. A yellow oil with a 100% yield was obtained.

STEP 6: The starting silyl protected alkene (5 g, 11.6 mmol) was dissolved under Argon at −78° C. cooled 50 mL dry THF (dried over Na/Benzophenone). 14.6 mL of 1.6M ⁿBuLi (23.4 mmol) was added dropwise to the mixture. The dark blue solution was warmed to 0° C. after which 4.2 mL of dry DMF was added. The red solution was stirred at room temperature for one hour. The solution was rotoevaporated and extracted with ethyl acetate and water (saturated with sodium bicarbonate). The organic layer was purified by silica gel chromatography (7 DCM: 3 Acetone as eluent). The product was a red liquid, and the yield was 93%. The aldehyde (4 g, 8.7 mmol) product was dissolved in 28.7 mL of THF and a mixture of HCl/H₂O (8 mL of 12.1M HCl in 39.84 mL of H₂O) was added. The mixture was stirred in a 42° C. bath for five hours after which the THF was rotoevaporated. The solution was neutralized with 5M aqueous ammonia solution and extracted with DCM. The product was purified by silica gel chromatography (7 Eth Aoc: 3Hex). Product was a red liquid. The yield was 87%.

STEP 7: The aldehyde alcohol (2 g, 5.8 mmol) was dissolved in 35 mL of THF. Iodobenzoic acid (1.44 g, 5.8 mmol), DCC (1.2 g, 5.8 mmol), and DMAP (0.21 g, 1.7 mmol) were added, and the mixture was stirred at room temperature overnight after which the product was purified by silica gel chromatography (7 Eth Aoc: 3 Hex and then with 7 Hex: 3 Eth Aoc). The product was a red viscous liquid, and the yield was 100%.

STEP 8: The starting aldehyde (3.51 g, 6.1 mmol) was dissolved in 37 mL of DMF. Added to the mixture was 12.2 mL of 1 M solution of a CF₂═CF—ZnBr reagent, along with Pd(PPh₃)₄ (189.7 mg, 0.16 mmol). The mixture was placed in a 75° C. bath overnight. After cooling, the mixture was extracted with ether and ethyl acetate, respectively. The residue was purified by silica gel chromatography (just DCM and then 7 Hex: 3 Eth Aoc). The product was a red solid, and the yield was 100%.

STEP 9: The trifluoro aldehyde (3.89 g, 7.4 mmol) was dissolved in 43 mL of chloroform, and tricyano furan (1.76 g, 8.8 mmol) and TEA (195 mL, 1.4 mmol) were added to the mixture. The mixture was stirred under Ar gas in a 61° C. bath. After stirring for 6½ hours, the product was purified by silica gel chromatography (1 Hex: 1 Ace2O and then 1 Hex: 1 Eth Aoc in a very long column). The product was a dark green solid, and the yield was 24%. The starting material in this reaction can be recovered and the reaction restarted if more product is desired.

### h) Other Compounds

Ethylcarbazole plasticizer and sensitizer (2,4,7-trinitro-9-fluorenylidene) malonitrile (TNFDM) are commercially available from Aldrich, used after recrystallization. Sensitizer PCBM[C60] is also commercially available from Aldrich and is used as received.

### Example 2

### Preparation of TPD Acrylate/Chromophore Type 10:1 Copolymer by AIBN Radical Initiated Polymerization

The charge transport monomer N-[(meth)acroyloxypropylphenyl]-N,N′,N′-triphenyl-(1,1′-biphenyl)-4,4′-diamine (TPD acrylate) (43.34 g), and the non-linear optical precursor monomer 5-[N-ethyl-N-4-formylphenyl]amino-pentyl acrylate (4.35 g), prepared as described in Example 1, were put into a three-necked flask. After toluene (400 mL) was added and purged by argon gas for 1 hour, azoisobutylnitrile (118 mg) was added into the solution. Then, the solution was heated to 65° C., while continuing to purge with argon gas.

After 18 hours of polymerization, the polymer solution was diluted with toluene. The polymer was precipitated from the solution and added to methanol, then the resulting polymer precipitate was collected and washed in diethyl ether and methanol. The white polymer powder was collected and dried. The yield of polymer was 66%.

The weight average and number average molecular weights were measured by gel permeation chromatography, using polystyrene standard. The results were Mn=10,600 and Mw=17,100, giving a polydispersity of about 1.61.

### Example 3

### Preparation of Photorefractive Composition

A photorefractive composition testing sample was prepared. The components of the composition were as follows:

| | |
|---|---|
| (i) TPD copolymer charge transport (described in Example 2): | 50.0 wt % |
| (ii) Prepared chromophore of 7-DCST: | 35.0 wt % |
| (iii) 9-ethylcarbazole plasticizer: | 13.0 wt % |
| (iv) DBM sensitizer | 2.0 wt % |

To prepare the composition, the components listed above were dissolved in toluene and stirred overnight at room temperature. After removing the solvent by rotary evaporator and vacuum pump, the residue was scratched and gathered.

To make testing samples, this powdery residue mixture was put on a glass slide and melted at 125° C. to make a film with a thickness of about 200-300 μm, or pre-cake. Small portions of this pre-cake were taken off and sandwiched between indium tin oxide (ITO) coated glass plates separated by a 100 μm spacer to form the individual samples.

### Measurement 1: Diffraction Efficiency

The diffraction efficiency was measured at 980 nm by four-wave mixing experiments. Steady-state and transient four-wave mixing experiments were done using two writing beams making an angle of 20.5 degree in air; with the bisector of the writing beams making an angle of 60 degree relative to the sample normal.

For the four-wave mixing experiments, two s-polarized writing beams with equal intensity of 0.1 W/cm² in the sample were used; the spot diameter was 2 mm. A p-polarized beam of 10 mW/cm² counter propagating with respect to the writing beam nearest to the surface normal was used to probe the diffraction gratings; the spot diameter of the probe beam in the sample was 1.5 mm. The diffracted and the transmitted probe beam intensities were monitored to determine the diffraction efficiency. This diffraction efficiency was defined as η.

### Measurement 2: Sensitivity

The diffraction efficiency was measured as a function of the applied field, using a procedure similar to that described in Measurement 1, by four-wave mixing experiments at 980 nm with s-polarized writing beams and a p-polarized probe beam. The angle between the bisector of the two writing beams and the sample normal was 60 degrees and the angle between the writing beams was adjusted to provide a 4.5 μm grating spacing in the material (about 20 degrees). The writing beams had equal optical powers of 0.2 W/cm², leading to a total optical power of 6 mW on the polymer, after correction for reflection losses. The beams were collimated to a spot size of approximately 2 mm. The optical power of the probe was 300 μW. The measurement of the grating buildup time was done as follows: an electric field (V/μm) was applied to the sample, and the sample was illuminated with two writing beams and the probe beam for 100 ms. Then, the evolution of the diffracted beam was recorded. Because higher laser intensity usually results in faster response time, we use the definition from literature (Nature, 2002, 418, 959) as below to compare the sensitivity of the photorefractive composition:

$$S = \frac{\sqrt{{η}_{ext} ( {t}_{exp} )}}{{I}_{WB , ext} {t}_{exp}}$$

Where ηₑₓₜ(tₑₓₚ) is the diffraction efficiency that can be achieved at the laser intensity I_{WB,ext} for the time period of tₑₓₚ.

### Measurement 3: Two Beam Coupling Gain

The two-beam coupling experiment is based on the direct measurement of energy exchanged between two optical beams that interfere inside a material. Two p-polarized writing beams with equal intensity of 0.1 W/cm² in the sample are incident upon the sample at typical incidence angles of 50° and 70° in air respectively; the spot diameter was 2 mm. The beam intensity of both writing beams was monitored before and during the photorefractive grating writing. The gain coefficiency was decided by:

$$Γ = \frac{cos φ}{d} ln ( \frac{b γ}{b + 1 - γ} )$$

where d is the thickness of the sample. b=I₂/I₁, γ=I₁₂/I₁, I₁ and I₁₂ are the transmitted intensity of beam 1 before and after coupling, respectively, and I₂ is the transmitted intensity of beam 2 before coupling.

Obtained Performance for Example 3:

| | |
|---|---|
| Initial diffraction efficiency (%): | 72% at 95 V/μm |
| Sensitivity: | 25 cm²J⁻¹ at 95 V/μm |
| Two-beam coupling gain: | 102 cm⁻¹ at 95 V/μm |
| Absorption coefficiency: | 30 cm⁻¹ |
| Net Gain coefficiency: | 72 cm⁻¹ at 95 V/μm |

### Example 4

A photorefractive composition testing sample was prepared in a manner similar to Example 3. The components of the composition were as follows:

| | |
|---|---|
| (i) TPD copolymer charge transport (described in Example 2): | 50.0 wt % |
| (ii) Prepared chromophore of 7-FDCST: | 35.0 wt % |
| (iii) 9-ethylcarbazole plasticizer: | 12.0 wt % |
| (iv) TNFDM sensitizer | 3.0 wt % |

Obtained Performance for Example 4:

| | |
|---|---|
| Initial diffraction efficiency (%): | 65% at 95 V/μm |
| Sensitivity: | 7.1 cm²J⁻¹ at 95 V/μm |
| Two-beam coupling gain: | 88 cm⁻¹ at 95 V/μm |
| Absorption coefficiency: | 50 cm⁻¹ |
| Net Gain coefficiency: | 38 cm⁻¹ at 95 V/μm |

### Example 5

A photorefractive composition testing sample was prepared in a manner similar to Example 3. The components of the composition were as follows:

| | |
|---|---|
| (i) TPD copolymer charge transport (described in Example 2): | 50.0 wt % |
| (ii) Prepared chromophore of 7-DCST: | 35.0 wt % |
| (iii) 9-ethylcarbazole plasticizer: | 13.0 wt % |
| (iv) TF-FTC sensitizer | 2.0 wt % |

Obtained Performance for Example 5:

| | |
|---|---|
| Initial diffraction efficiency (%): | 73% at 95 V/μm |
| Sensitivity: | 6.0 cm²J⁻¹ at 95 V/μm |
| Two-beam coupling gain: | 80 cm⁻¹ at 95 V/μm |
| Absorption coefficiency: | 10 cm⁻¹ |
| Net Gain coefficiency: | 70 cm⁻¹ at 95 V/μm |

### Example 6

A photorefractive composition testing sample was prepared in a manner similar to Example 3. The components of the composition were as follows:

| | |
|---|---|
| (i) TPD copolymer charge transport (described in Example 2): | 50.0 wt % |
| (ii) Prepared chromophore of 7-FDCST: | 35.0 wt % |
| (iii) 9-ethylcarbazole plasticizer: | 11.0 wt % |
| (iv) TF-FTC sensitizer | 4.0 wt % |

Obtained Performance for Example 6:

| | |
|---|---|
| Initial diffraction efficiency (%): | 74% at 95 V/μm |
| Sensitivity: | 11.0 cm²J⁻¹ at 95 V/μm |
| Two-beam coupling gain: | 112 cm⁻¹ at 95 V/μm |
| Absorption coefficiency: | 32 cm⁻¹ |
| Net Gain coefficiency: | 80 cm⁻¹ at 95 V/μm |

### Example 7

A photorefractive composition testing sample was prepared in a manner similar to Example 3. The components of the composition were as follows:

| | |
|---|---|
| (i) TPD copolymer charge transport (described in Example 2): | 50.0 wt % |
| (ii) Prepared chromophore of 7-FDCST: | 35.0 wt % |
| (iii) 9-ethylcarbazole plasticizer: | 14.0 wt % |
| (iv) PCBM[C60] sensitizer | 1.0 wt % |

Obtained Performance for Example 7:

| | |
|---|---|
| Initial diffraction efficiency (%): | 77% at 95 V/μm |
| Sensitivity: | 16.6 cm²J⁻¹ at 95 V/μm |
| Two-beam coupling gain: | 102 cm⁻¹ at 95 V/μm |
| Absorption coefficiency: | 32 cm⁻¹ |
| Net Gain coefficiency: | 70 cm⁻¹ at 95 V/μm |

### Example 8

A photorefractive composition testing sample was prepared in a manner similar to Example 3. The components of the composition were as follows:

| | |
|---|---|
| (i) TPD copolymer charge transport (described in Example 2): | 50.0 wt % |
| (ii) Prepared chromophore of APDC: | 35.0 wt % |
| (iii) 9-ethylcarbazole plasticizer: | 13.0 wt % |
| (iv) DBM sensitizer | 2.0 wt % |

Obtained Performance for Example 8:

| | |
|---|---|
| Initial diffraction efficiency (%): | 78% at 85 V/μm (peak) |
| Sensitivity: | 1.3 cm²J⁻¹at 95 V/μm |
| Two-beam coupling gain: | 216 cm⁻¹ at 95 V/μm |
| Absorption coefficiency: | 60 cm⁻¹ |
| Net Gain coefficiency: | 156 cm⁻¹ at 95 V/μm |

### Comparative Example

A photorefractive composition was obtained in a manner similar to Example 3, except that no sensitizer ingredient was provided. The components of the composition were as follows:

| | |
|---|---|
| (i) TPD copolymer charge transport (described in Example 2): | 50.0 wt % |
| (ii) Prepared chromophore of 7-FDCST: | 30.0 wt % |
| (iii) 9-ethylcarbazole: | 20.0 wt % |

Obtained Performance for the Comparative Example:

| | |
|---|---|
| Initial diffraction efficiency (%): | no signal |
| Sensitivity: | no signal |
| Two-beam coupling gain: | no signal |
| Absorption coefficiency: | <1 cm⁻¹ |
| Net Gain coefficiency: | n/a |

The initial diffraction efficiency shows the ability of a grating to bend the incident laser beam, with higher values being an indicator of improved performance. In the setup used to measure initial diffraction efficiency in these Examples, an internal optical loss exists due to the optics used. Therefore, the maximum diffraction efficiency that can be achieved in this configuration is about 85%. Thus, initial diffraction efficiency values over 65-70% are considered to indicate high diffraction efficiency materials.

The sensitivity of the composition shows the speed at which a grating can be written in a given time duration of exposure of the composition to NIR light. The two-beam coupling gain measures the ability of the photorefractive composition to transfer energy from one writing beam to another. Higher gain is desired in various applications, such as beam amplification, signal processing, etc. Preferably, the gain should be larger than the absorption loss, which means that net gain is the two-beam coupling gain minus the absorption coefficiency is preferably larger than zero. Each of Examples 3-8 show good gain values, but also good net gain values minus the absorption loss.

No grating formation ability was observed in the Comparative Example, which did not contain a sensitizer, upon irradiation with a 980 nm laser. Therefore, compositions that do not have sensitizer have no absorption in the NIR spectrum. Good diffraction efficiency was only observed in the Comparative Example after it was irradiated by a 532 nm green laser. Examples 3-8, each of which incorporated a NIR sensitive sensitizer, exhibited grating formation and good diffraction efficiency upon irradiation with a NIR laser. NIR sensitivity is desirable because in some applications, such as bio-imaging, the NIR laser has better penetration in tissues and skin and also provides more accurate information. Other applications, such as sensors, dark vision, and telecommunications are frequently preformed using light in the NIR region.

All literature references and patents mentioned herein are hereby incorporated in their entireties. Although the foregoing invention has been described in terms of certain preferred embodiments, other embodiments will become apparent to those of ordinary skill in the art in view of the disclosure herein without departing from the scope of the invention. Accordingly, all such modifications and changes are intended to fall within the scope of the invention, as defined by the appended claims.

What is claimed is:

1. A composition that is photorefractive upon irradiation by a near infrared (NIR) laser;
wherein the composition comprises a sensitizer and a polymer;
wherein the polymer comprises a first repeating unit that includes at least one moiety selected from the group consisting of the following formulae (Ia), (Ib), and (Ic): 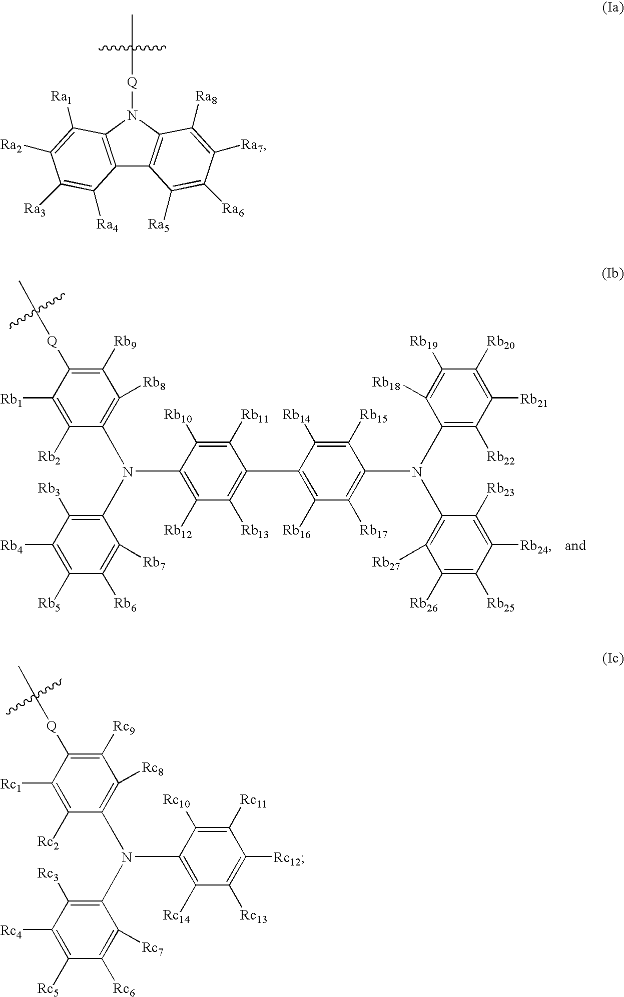
wherein each Q in formulae (Ia), (Ib) and (Ic) independently represents an alkylene group or a heteroalkylene group, Ra₁-Ra₈, Rb₁-Rb₂₇ and Rc₁-Rc₁₄ in (Ia), (Ib), and (Ic) are each independently selected from the group consisting of hydrogen, linear or branched optionally substituted C₁-C₁₀ alkyl or heteroalkyl, and optionally substituted C₆-C₁₀ aryl;
wherein the sensitizer absorbs light at a NIR laser wavelength and is selected from the group consisting of a fullerene, a nitro-substituted fluorenone, and a second order nonlinear sensitizer with the following structure:
W—Y—Z (II);
wherein W in formula (II) is an electron donor group, Y in formula (II) is a π-conjugated group, and Z in formula (II) is an electron acceptor group,
wherein the composition comprises the sensitizer in an amount in the range of about 0.01% to about 5% by weight of the composition.

2. The composition of claim 1, wherein Z has an electron affinity equal to, or greater than that of

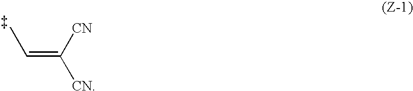

3. The composition of claim 1, wherein Z is selected from the group consisting of the following moieties:

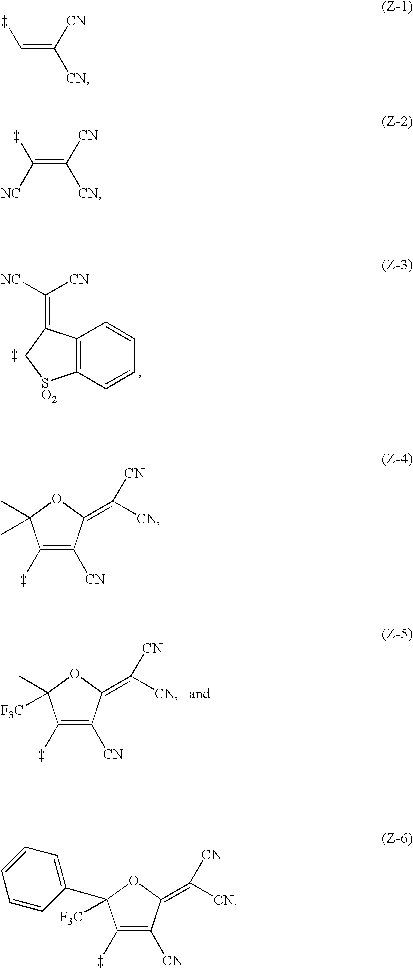

4. The composition of claim 1, wherein Y comprises a π-conjugated system comprising at least 8 atoms.

5. The composition of claim 1, wherein Y comprises a π-conjugated system comprising at least 10 atoms.

6. The composition of claim 1, wherein Y in formula comprises one or more groups selected from an aromatic ring group, a polyene group, a polyyne group, a quinomethide group, and their derivatives containing heteroatoms wherein at least one carbon and/or at least one C═C or C≡C bond is replaced by a heteroatom.

7. The composition of claim 1, wherein Y is selected from the following moieties: 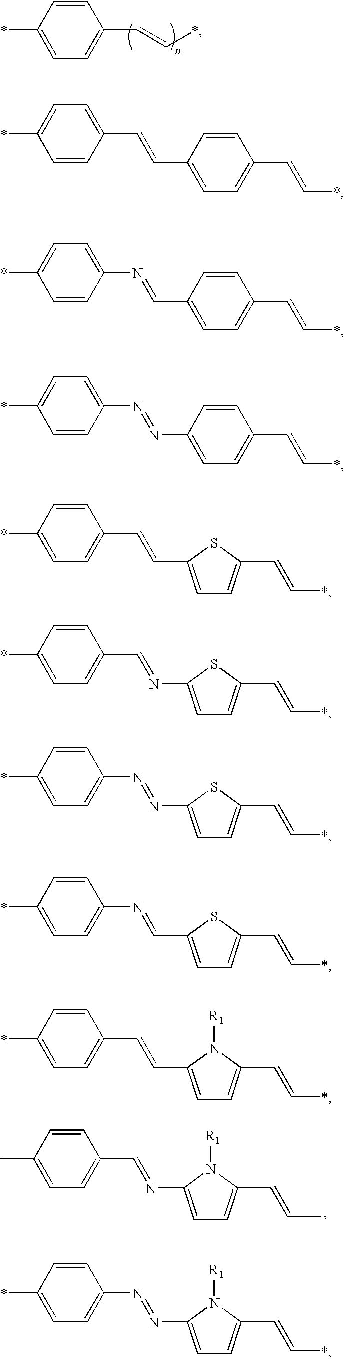 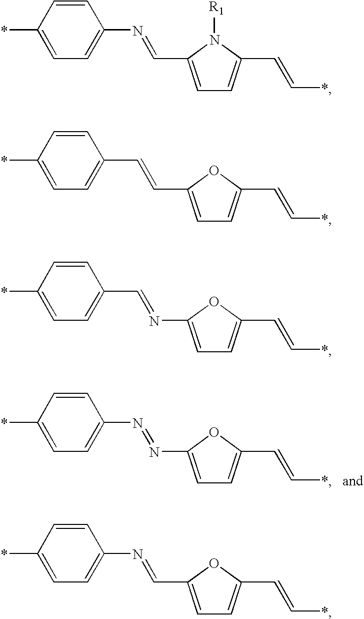
wherein n in Y of formula (II) is 2 or more and R₁ in Y of formula (II) is independently selected from the group consisting of hydrogen, alkenyl, alkyl, alkynyl, aryl, cycloalkenyl, cycloalkyl, heteroaryl, and optionally substituted variants thereof.

8. The composition of claim 1, wherein said W in formula (II) is selected from the group consisting of NRz₁Rz₂, Rz₁, ORz₁, PRz₁Rz₂, SiRz₁Rz₁ₐRz₂, SRz₁, wherein Rz₁, Rz₁ₐ, and Rz₂ are independently selected from the group consisting of alkenyl, alkyl, alkynyl, aryl, cycloalkenyl, cycloalkyl, heteroaryl, and optionally substituted variants thereof.

9. The composition of claim 1, wherein W in formula (II) is selected from the group consisting NRz₁Rz₂, Rz₁, and ORz₁, wherein Rz₁ and Rz₂ are independently selected from the group consisting of —(CH₂)ₓ—O—C(O)—Rz₃, —(CH₂)ₓ—NH—C(O)—Rz₃, alkenyl, alkyl, alkynyl, aryl, cycloalkenyl, cycloalkyl, heteroaryl, and optionally substituted variants thereof, wherein x in W of formula (II) is between 1 and about 6 and Rz₃ is an optionally substituted aryl, heteroaryl, heterocycle, cycloalkyl, alkenyl, or alkynyl.

10. The composition of claim 8, wherein W in formula (II) is selected from:

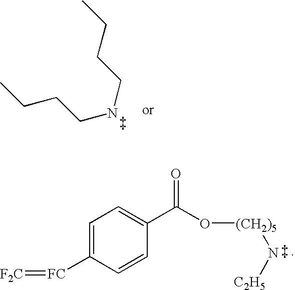

11. The composition of claim 1, wherein the fullerene is selected from optionally substituted C₆₀, optionally substituted C₇₀, optionally substituted C₈₄, optionally substituted single-wall carbon nanotube, or optionally substituted multi-wall carbon nanotube.

12. The composition of claim 11, wherein the fullerene is selected from soluble C₆₀ derivative [6,6]-phenyl-C61-butyricacid-methylester, soluble C₇₀ derivative [6,6]-phenyl-C₇₁-butyricacid-methylester, or soluble C₈₄ derivative [6,6]-phenyl-C₈₅-butyricacid-methylester.

13. The composition of claim 1, wherein the nitro-substituted fluorenone is selected from the group consisting of nitrofluorenone, 2,4-dinitrofluorenone, 2,4,7-trinitrofluorenone, (2,4,7-trinitro-9-fluorenylidene)malonitrile.

14. The composition of claim 1, wherein the composition comprises the sensitizer in an amount in the range of about 0.1% to about 2% by weight of the composition.

15. The composition of claim 1, further comprising an ingredient which provides additional non-linear optical functionality represented by the following formula:
D-B-A (III)
wherein the ingredient providing additional non-linear optical functionality does not absorb light at a NIR laser wavelength; and
wherein D in formula (III) is an electron donor group, B in formula (III) is a π-conjugated group, and A in formula (III) is an electron acceptor group.

16. The composition of claim 15, wherein said D in formula (III) is selected from the group consisting of NRz₁Rz₂, Rz₁, ORz₁, PRz₁Rz₂, SiRz₁Rz₁ₐRz₂, SRz₁, wherein Rz₁, Rz₁ₐ, and Rz₂ are independently selected from the group consisting of alkenyls, alkyls, alkynyls, aryls, cycloalkenyls, cycloalkyls, heteroaryls, and optionally substituted variants thereof.

17. The composition of claim 15, wherein said B in formula (III) comprises a group selected from an aromatic ring group, a polyene group, a polyyne group, a quinomethide group, and their derivatives containing heteroatoms wherein at least one carbon and/or at least one C═C or C≡C bond is replaced by a heteroatom.

18. The composition of claim 17, wherein said B in formula (III) is selected from the following moieties: 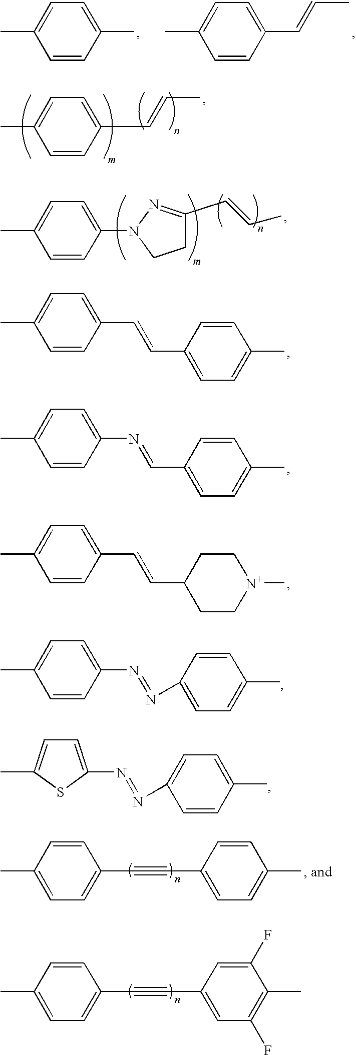
wherein m and n in B of formula (III) are each independently integers of 2 or less, provided that at least one m or n is at least 1.

19. The composition of claim 15, wherein said A in formula (III) is selected from the group consisting of NO₂, CN, C═C(CN)₂, CF₃, F, Cl, Br, I, S(═O)₂CₙF₂ₙ₊₁), S(CₙF₂ₙ₊₁)═NSO₂CF₃, and S(CₙF₂ₙ₊₁)═NSO₂CₙF₂ₙ₊₁; and wherein each n in A of formula (III) is independently an integer from 1 to 10.

20. The composition of claim 15, wherein the ingredient providing additional non-linear optical functionality comprises a chromophore.

21. The composition of claim 20, wherein the composition comprises chromophore in an amount in the range of about 10% to about 60% by weight of the composition.

22. The composition of claim 20, wherein the composition comprises chromophore in an amount in the range of about 20% to about 40% by weight of the composition.

23. The composition of claim 1, further comprising a plasticizer.

24. The composition of claim 23, wherein the plasticizer is selected from the group consisting of N-alkyl carbazole, triphenylamine derivatives, and derivatives thereof.

25. The composition of claim 23, wherein the plasticizer is selected from the following formulae: 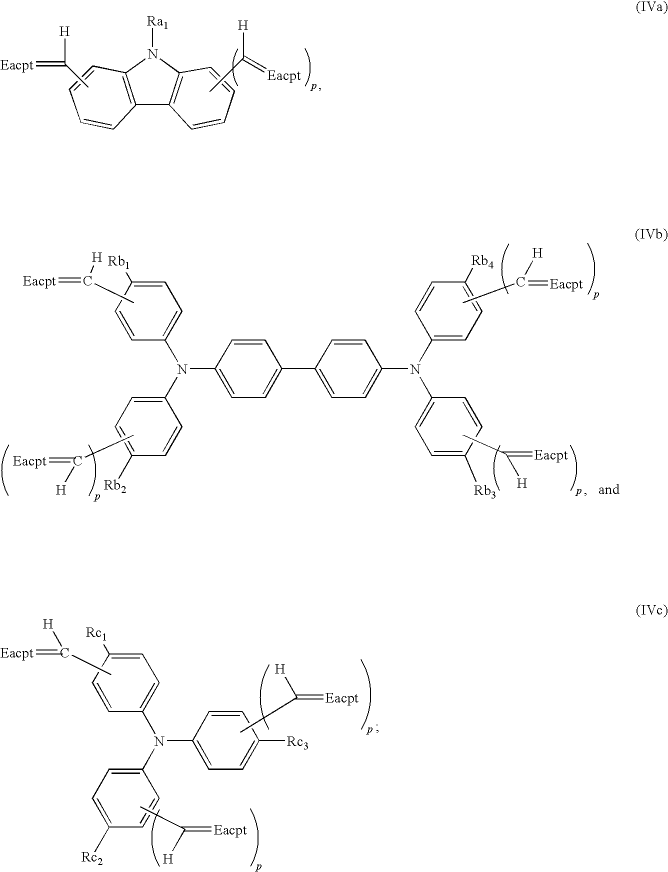
wherein Ra₁, Rb₁-Rb₄ and Rc₁-Rc₃ in formulae (IVa), (IVb), and (IVc) are each independently selected from the group consisting of hydrogen, linear C₁-C₁₀ alkyl, branched C₁-C₁₀ alkyl and C₆-C₁₀ aryl; p is 0 or 1; and Eacpt in formulae (IVa), (IVb), and (IIIc) is an electron acceptor group.

26. The composition of claim 1, wherein the first repeating unit of the polymer comprises a repeating unit selected from the group consisting of the following formulae: 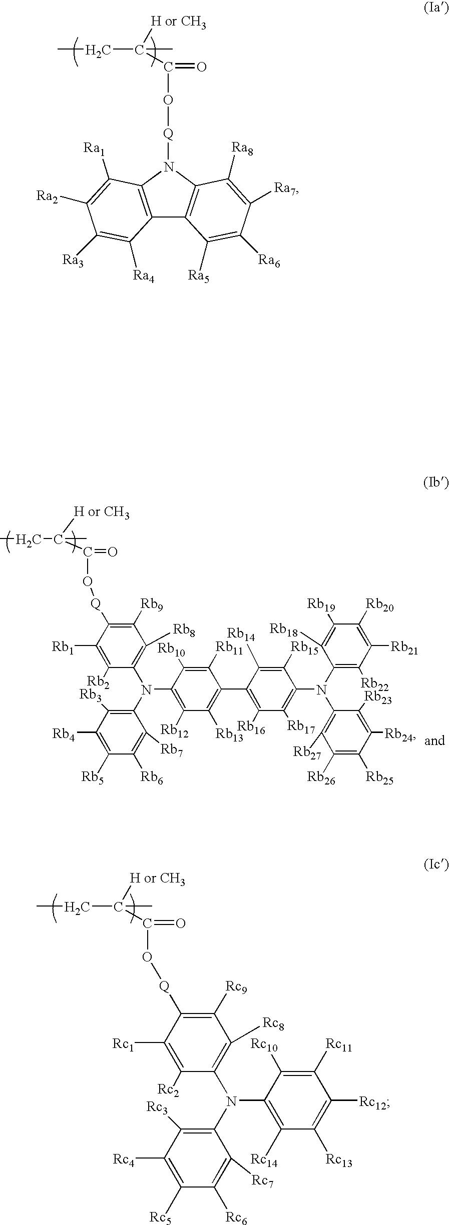
wherein each Q in formulae (Ia′), (Ib′) and (Ic′) independently represents an alkylene group or a heteroalkylene group, Ra₁-Ra₈, Rb₁-Rb₂₇ and Rc₁-Rc₁₄ in (Ia′), (Ib′), and (Ic′) are each independently selected from the group consisting of hydrogen, linear or branched optionally substituted C₁-C₁₀ alkyl or heteroalkyl, and optionally substituted C₆-C₁₀ aryl.

27. The composition of claim 1, wherein the composition has a transmittance of higher than about 30% at a thickness of 100 μm when irradiated by a 980 nm laser.

28. The composition of claim 1, wherein the composition is photorefractive upon irradiation by a NIR laser at a wavelength of about 980 nm.

29. An optical device which comprises the composition according to claim 1.

30. A method for modulating light, comprising the steps of:
providing a photorefractive composition according to claim 1; and
irradiating the photorefractive composition with a NIR laser to form a grating, thereby modulating light.
